(19) United States
(12) Patent Application Publication
(10) Pub. No.: US 2025/0227594 A1
(43) Pub. Date: Jul. 10, 2025

(54) BASE STATION AND BEAM JOINT PREDICTION AND HANDOVER ASSISTED BY ARTIFICIAL INTELLIGENCE

(71) Applicant: Sony Group Corporation, Tokyo (JP)

(72) Inventors: Ke MA, Tokyo (JP); Lebin YAO, Tokyo (JP); Zhaocheng WANG, Tokyo (JP); Yingshuang BAI, Tokyo (JP); Chen SUN, Tokyo (JP)

(73) Assignee: Sony Group Corporation, Tokyo (JP)

(21) Appl. No.: 18/985,196

(22) Filed: Dec. 18, 2024

(30) Foreign Application Priority Data
Dec. 29, 2023 (CN) 202311854833.X

(51) Int. Cl. H04W 36/30; H04L 41/16; H04W 36/00; H04W 36/32

(52) U.S. Cl. CPC H04W 36/305; H04L 41/16; H04W 36/0058; H04W 36/32

(57) ABSTRACT

The present disclosure relates to base station and beam joint prediction and handover assisted by artificial intelligence. There is provided a method for radio communication, comprising: predetermining that a radio link failure (RLF) or handover will occur by using an artificial intelligence (AI) model, wherein, the predetermination is based at least on radio link condition information related to a user equipment (UE), and the radio link condition information comprises at least information reflecting condition of a radio link between the UE and a serving base station (SBS).

### CROSS-REFERENCE TO RELATED APPLICATIONS

This application claims the benefit of priority to the Chinese patent application No. 202311854833.X filed on Dec. 29, 2023 and entitled “BASE STATION AND BEAM JOINT PREDICTION AND HANDOVER ASSISTED BY ARTIFICIAL INTELLIGENCE”, which is hereby incorporated by reference in its entirety into the present application for all purposes.

### TECHNICAL FIELD

The present disclosure relates generally to radio communication technology, and more specifically, to a prediction solution of a target base station and serving beams thereof assisted by artificial intelligence (AI).

### BACKGROUND

Due to huge advantages of massive antenna array, massive bandwidth resources and dense networking deployment, a millimeter wave frequency band can support ultra-high speed radio communication of several gigabits per second, and has become one of key alternative technologies of next-generation mobile communication. However, since both free space propagation loss and molecular absorption attenuation increase with an increase in frequency, a millimeter wave channel has a high propagation attenuation. How to solve this problem has become one of focuses of millimeter wave communication research. Very fortunately, the millimeter wave has an advantage of shorter wavelength, which makes it easy for the massive antenna array to be integrated on a limited panel, thereby achieving directional convergence transmission of energy by using beamforming technology, to compensate the propagation attenuation. However, a millimeter wave radio frequency device has high power consumption and cost, resulting in a small number of radio frequency links with which the millimeter wave communication can be equipped and difficulty in effective implementation of traditional digital beamforming. Therefore, in the millimeter wave communication, an analog beamforming structure based on a phaser is often adopted, wherein each way of signal is subjected to a phase shift with a different phase and transmitted by a plurality of antennas to form a directionally transmitted beam. In a practical communication system, in order to reduce complexity of the beamforming, a beamforming vector is usually selected directly from a predefined beamforming codebook, which contains beams corresponding to different directions. In order to support the above hardware structure, beam management is required in the millimeter wave communication, that is, an optimal beam with maximum receiving power is acquired and maintained for a user equipment (UE), thereby achieving reliable transmission.

With the enlightenment of a powerful adaptive-nonlinear fitting capability of deep learning, intelligent communication where deep learning is applied to radio communication has become one of 6G focus directions. As one of three typical scenarios of NR (New Radio), 3GPP has, on the beam management, developed standardization discussions on radio communication assisted by deep learning, wherein deep learning can play two aspects of roles. On one hand, the deep learning can effectively mine nonlinear features in the beam management, improving the beam management performance. On the other hand, the deep learning can adaptively model a complex high-dimensional radio environment in a data-driven form, and adapt to environmental fluctuations in time through online learning, helping to achieve efficient beam management based on a specific environment.

Meanwhile, compared with three traditional beam management methods, the deep learning has remarkable advantages:

(1) In a limited beam direction, a most common beam management solution is beam search, i.e. scanning and selecting an optimal beam with highest receiving power, but this tends to bring great overhead. In contrast, deep learning can extract inherent nonlinear characteristics of a beam measurement signal, thereby effectively reducing search overhead.

(2) A large amount of work is to estimate an optimal beam direction by using mathematical properties of a channel model, but this method highly depends on explicit channel priori hypotheses, with a severely degraded performance when a real scenario is not in conformity with hypotheses. However, deep learning, faced with a real radio environment, can achieve end-to-end learning in a data-driven form, without explicit priori knowledge.

(3) Traditional machine learning methods such as support vector machines (SVMs) are used for the beam management, but these methods are often limited in fitting capabilities, whereas deep learning, depending on massive learnable parameters, has a stronger nonlinear fitting capability.

### SUMMARY

A brief summary of the present disclosure is presented herein to provide a basic understanding of some aspects of the present disclosure. However, it should be understood that this summary is not an exhaustive overview of the present disclosure. It is not intended to determine key or critical elements of the present disclosure or to limit the scope of the present disclosure. Its purpose is only to present certain concepts of the present disclosure in a simplified form as a prelude to the more detailed description to be presented later.

According to an aspect of the present disclosure, there is provided a method for radio communication, comprising: predetermining that a radio link failure (RLF) or handover will occur by using an artificial intelligence (AI) model, wherein, the predetermination is based at least on radio link condition information related to a user equipment (UE), and the radio link condition information comprises at least information reflecting condition of a radio link between the UE and a serving base station (SBS). According to another aspect of the present disclosure, there is provided a system for radio communication, comprising one or more processors and a memory. The memory stores computer-readable program instructions which, when executed by the one or more processors, cause the method as described above to be performed.

According to another aspect of the present disclosure, there is provided a system for radio communication, comprising one or more processors and a memory. The memory stores computer-readable program instructions which, when executed by the one or more processors, cause the method as described above to be performed.

According to another aspect of the present disclosure, there is provided a non-transitory computer-readable storage medium, storing computer-readable program instructions which, when executed by one or more processors, cause the method for radio communication as described above to be performed.

According to another aspect of the present disclosure, there is provided a method performed by a user equipment (UE), comprising predicting an occurrence probability of a radio link failure (RLF) or handover by using a first artificial intelligence (AI) model, wherein, the prediction is based at least on radio link condition information related to the user equipment (UE), the radio link condition information comprising at least information reflecting condition of a radio link between the UE and a serving base station.

According to another aspect of the present disclosure, there is provided a user equipment (UE), comprising one or more processors and a memory, the memory storing computer-readable program instructions which, when executed by the one or more processors, cause the method as described above to be performed.

According to another aspect of the present disclosure, there is provided a non-transitory computer-readable storage medium, storing computer-readable program instructions which, when executed by one or more processors, cause the method performed by a user equipment (UE) as described above to be performed.

### BRIEF DESCRIPTION OF THE DRAWINGS

The present disclosure may be better understood by referring to the following DETAILED DESCRIPTION presented in conjunction with the accompanying drawings, wherein same or similar reference numerals used in all the drawings represent same or similar elements. The accompanying drawings along with the DETAILED DESCRIPTION below, which are incorporated in and form a part of this specification, further illustrate embodiments of the present disclosure and explain the principles and advantages of the present disclosure. In the drawings:

FIG. 1 is a flow diagram illustrating an exemplary conditional handover process according to the related art.

FIG. 2 is a schematic diagram illustrating an exemplary beam failure recovery process according to the related art.

FIGS. 3A to 3D are flow diagrams illustrating exemplary methods for radio communication according to embodiments of the present disclosure.

FIG. 4 is a schematic diagram illustrating an exemplary LSTM structure according to an embodiment of the present disclosure.

FIG. 5 is a schematic diagram illustrating a structure of an exemplary base station-beam handover joint prediction model according to an embodiment of the present disclosure.

FIG. 6 is a flow diagram illustrating an exemplary method for radio communication according to an embodiment of the present disclosure.

FIG. 7 is a diagram illustrating a structure of an exemplary base station-beam handover joint prediction model according to an embodiment of the present disclosure.

FIG. 8 is a flow diagram illustrating an exemplary method for radio communication according to an embodiment of the present disclosure.

FIG. 9 illustrates adjacent beam measurement according to an embodiment of the present disclosure.

FIG. 10 illustrates beam measurement based on a probability priority according to an embodiment of the present disclosure.

FIG. 11 is a flow diagram illustrating an exemplary method of BS-beam handover joint prediction based on downlink BFR measurement, according to an embodiment of the present disclosure.

FIG. 12 is a flow diagram illustrating an exemplary method of BS-beam handover joint prediction based on uplink BFR measurement, according to an embodiment of the present disclosure.

FIG. 13 is a flow diagram illustrating an exemplary UE-side beam pattern feedback method according to an embodiment of the present disclosure.

FIG. 14 illustrates a UE-side beam absolute angle calculation example according to an embodiment of the present disclosure.

FIG. 15 illustrates an effect of UE's own rotation on a UE beam angle.

FIG. 16 is a flow diagram illustrating a base station-beam handover method according to an embodiment of the present disclosure.

FIG. 17 is a flow diagram illustrating a base station-beam handover method according to an embodiment of the present disclosure.

FIG. 18 is a flow diagram illustrating an exemplary method of collecting training data according to an embodiment of the present disclosure.

FIG. 19 illustrates a reduced prediction output according to an embodiment of the present disclosure.

FIG. 20 is a flow diagram illustrating a method of activating an AI-assisted RLF/handover prediction service according to an embodiment of the present disclosure.

FIG. 21 is a flow diagram illustrating a method of activating and deactivating a BS-beam handover joint prediction model for a UE according to an embodiment of the present disclosure.

FIG. 22 illustrates an example of triggering model update based on a relative threshold according to an embodiment of the present disclosure.

FIG. 23 illustrates an exemplary radio channel environment according to an embodiment of the present disclosure.

FIG. 24 illustrates normalized beam gain performance of BS-beam handover joint prediction according to an embodiment of the present disclosure.

FIG. 25 illustrates a variation curve of accuracy of BS prediction with the number of base stations according to an embodiment of the present disclosure.

FIGS. 26A-26C respectively illustrate block diagrams of exemplary configurations of a base station according to some embodiments of the present disclosure.

FIGS. 27A and 27B respectively illustrate flow diagrams of an exemplary method for radio communication according to an embodiment of the present disclosure.

FIGS. 27C and 27D respectively illustrate block diagrams of exemplary configurations of a user equipment according to an embodiment of the present disclosure.

FIG. 28 is a block diagram illustrating a first example of a schematic configuration of a base station to which the technique of the present disclosure can be applied.

FIG. 29 is a block diagram illustrating a second example of a schematic configuration of a base station to which the technique of the present disclosure can be applied.

FIG. 30 is a block diagram illustrating an example of a schematic configuration of a smartphone to which the technique of the present disclosure can be applied.

FIG. 31 is a block diagram illustrating an example of a schematic configuration of a car navigation device to which the technique of the present disclosure can be applied.

Features and aspects of the present disclosure will be clearly understood by reading the following DETAILED DESCRIPTION with reference to the accompanying drawings.

### DETAILED DESCRIPTION

Various exemplary embodiments of the present disclosure will be described in detail hereinafter with reference to the accompanying drawings. For clarity and conciseness, not all implementations of the embodiments have been described in this description. However, it should be noted that, when the embodiments of the present disclosure are implemented, many implementation-specific settings may be made according to specific needs, so as to achieve specific goals of developers. Moreover, it should also be appreciated that although development work might be complex and laborious, for those skilled in the art benefiting from this disclosure, such development disclosure is only a routine task.

Furthermore, it should be noted that in order to avoid obscuring the present disclosure due to unnecessary details, only processing steps and/or device structures germane to the technical solutions of the present disclosure are shown in the drawings. The following description of exemplary embodiments is merely illustrative and is not intended to be any limitation on this disclosure or its application.

The meanings of some abbreviations appearing in this disclosure are listed first below.
3GPP (3rd Generation Partnership Project)
AoA (Angle of Arrival)
AoD (Angle of Department)
BF (Beam Failure)
BFR (Beam Failure Recovery)
BS (Base Station)
CSI (Channel State Information)
CSI-RS (Channel State Information Reference Signal)
CNN (Convolutional Neural network)
MIB (Master Information Block)
NR (New radio)
PBCH (Physical Broadcasting Channel)
PBS (Predicted Base Station) (specifically referring to an accessible base station predicted by a model in this disclosure)
PCI (Physical Cell Index)
PSS (Primary Synchronization Signal)
SBS (Serving Base Station) (specifically referring to a serving base station before a base station handover in this disclosure)
SSB (Synchronization Signal Block)
SSS (Secondary Synchronization Signal)
SRS (Sounding Reference Signal)
SVM (Support Vector Machine)
RLF (Radio Link Failure)
RSRP (Reference Signal Receiving Power)
RRC (Radio Resource Control)
TBS (Target Base station) (specifically referring to an access base station after a UE performs RRC re-establishment in this disclosure)
UE (User Equipment) (user)
ULA (Uniform Linear Array)

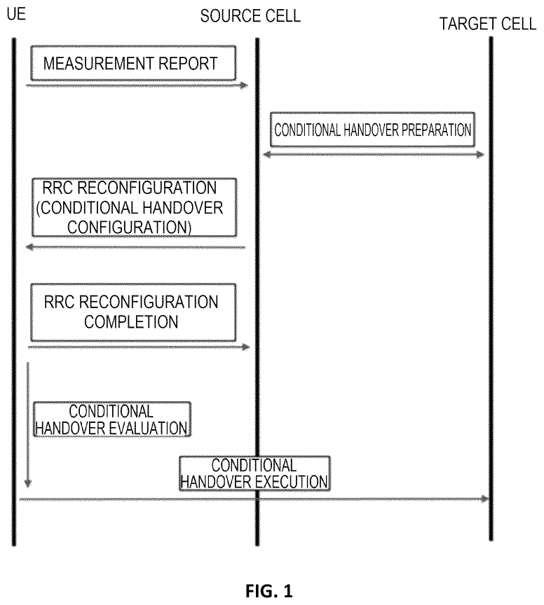

Although deep learning brings significant performance gain in beam management, the existing deep learning-assisted beam management method tends to only focus on single base station's (intra-BS) beam prediction, while inter-BS handovers frequently occur in addition to beam switch within a single BS, in high-speed moving scenarios. In the traditional BS handover process, a UE monitors reference signal receiving power (RSRP) of a neighboring BS and sends a measurement report to a serving BS, and after the serving BS requests and obtains handover confirmation of a target BS, the serving BS notifies the UE of a handover configuration through an RRC reconfiguration message, and then the UE immediately performs a handover. A conditional handover (CHO) is further introduced in the R16 standard, at this time, the target BS performs conditional handover preparation, and the UE decides an actual trigger time of the handover according to a pre-configured condition, as shown in FIG. 1. In this way, within the time when signaling interaction is made between the UE and a source base station and between the source base station and a target base station, occurrence of a UE handover failure due to a change in a radio link state can be avoided, thereby improving robustness in the user's handover process. However, using the existing conditional handover mechanism, in a high-frequency scenario such as a millimeter wave frequency band, the UE needs to search for a larger number of candidate beams sequentially emitted by the target base station one by one to determine a beam meeting a handover condition, so that there is still certain beam scanning latency and overhead.

Furthermore, in the existing NR standard, an event that the communication quality of the current serving BS (SBS) does not meet requirements of the UE is defined by using a radio link failure (RLF). When the RLF is triggered, the UE performs RRC re-establishment and monitors synchronization signals and PBCH blocks (SSBs) broadcast by surrounding BSs, to search for an accessible BS and its optimal beam, but this may bring larger RRC re-establishment latency and overhead.

To reduce the above overhead, the present disclosure contemplates that an RLF or handover is predicted by using deep learning, and joint prediction of BS and its beam handover is performed. Specifically, since deep learning can extract high-dimensional radio environment features (the high-dimensional radio environment features are features contained in a surrounding scattering environment, including features such as locations and scattering properties of scatterers (such as buildings, walls, and trees). Usually, the more the number and types of scatterers contained in one environment, the higher the overall dimension of corresponding radio environment features) around the BS and UE, it can establish mapping from link-related information of a serving base station and neighboring base stations to the user location, which provides feasibility for predicting an accessible BS and an appropriate serving beam thereof. On the basis of the prediction, the predicted accessible predicted BS (PBS) and the UE only need measuring a small number of high-quality beams predicted to complete the BS handover, thereby remarkably reducing handover overhead.

In general, the present disclosure relates to, first predetermining whether a radio link failure (RLF) or handover (e.g., a radio link failure (RLF) or handover-related event, including an A3 event) will occur by using artificial intelligence (AI), based at least on link condition information related to a UE, and then in the case of predetermining that the RLF or handover will occur, predicting a target BS-beam set by using AI for performing a subsequent handover, based at least on the link condition information related to the UE. An AI model can be implemented, which can include one or more AI sub-models deployed on a serving base station or on a serving base station and the UE. By the one or more AI sub-models, at least one of the predetermination of the RLF or handover or the prediction of the target BS-beam set is achieved.

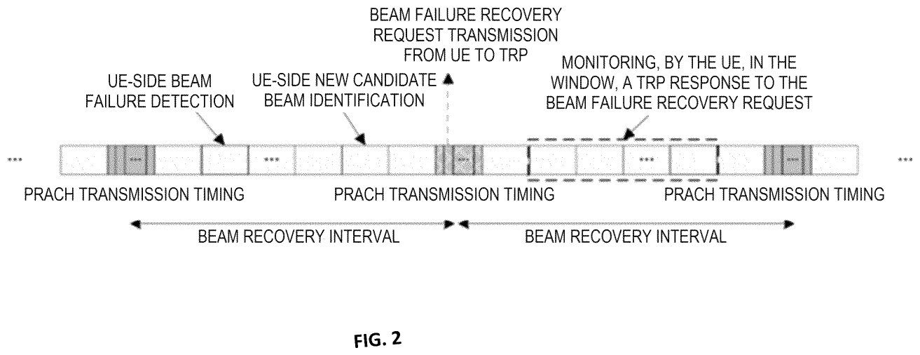

In order to achieve the above predetermination of the RLF or handover and/or prediction of the target BS-beam set, the radio link information related to the UE needs to be obtained as a prediction input. In the NR standard, considering that RRC re-establishment overhead after RLF trigger is large, and a main reason for degradation of the UE communication quality in a mobile scenario is beam misalignment rather than leaving an SBS cell range, in the existing NR standard, a beam failure (BF) event is defined to avoid frequent RLF trigger, as shown in FIG. 2. Specifically, as shown in FIG. 2, a UE detects a beam failure and determines a new candidate beam, and then the UE sends a beam failure recovery (BFR) request to a BS by means of random access, and monitors a reply of the BS to the BFR request. After the UE successfully finds a candidate beam meeting its own communication requirement and receives the reply of the BS to the BFR request, the BFR process is completed, without triggering an RLF and a complex RRC re-establishment process.

There are two disadvantages of the traditional BFR that: (1) usually, the BFR is triggered when the service quality is insufficient to support the basic communication requirement, and if the BFR fails, the RLF is directly triggered, so that the UE cannot communicate with the current serving BS so as to provide, by the serving BS, assistance in time; (2) limited by the timing of triggering the BFR, the number of measurable beams may be small, making it difficult to ensure that a measured new candidate beam is an optimal one. Therefore, in some embodiments of the present disclosure, RLF prediction may be made by using an artificial intelligence model, so as to trigger, when the UE is still capable of data communication with the current serving base station, corresponding candidate beam measurement in advance, and report the measurement result to the current serving base station. On the other hand, since the embodiments of the present disclosure perform the candidate beam measurement in advance, the measurement range can be increased, thereby improving the quality of the measurement result. According to other embodiments of the present disclosure, the measurement result of the candidate beam that is triggered in advance according to the AI prediction may be taken as an input of target BS-beam set prediction.

In addition, when faced with complex radio environments, the traditional method is difficult to accurately model the relation between the CSI information of the SBS and the BS-beam handover; meanwhile, the total number of candidate beams of all neighboring BSs around the SBS is large, making it difficult to ensure accurate prediction. According to some embodiments of the present disclosure, radio environmental features around the SBS are adaptively modeled by employing deep learning, which can achieve accurate prediction; and output space can be reduced according to training set labels, improving the prediction performance.

In the present disclosure, the serving base station (SBS) refers to a serving BS before BS handover. The prediction model according to the embodiment of the present disclosure can be deployed on the SBS to fully extract the radio environment features around the SBS, improving the prediction performance.

The predicted BS (PBS) refers to an accessible BS predicted, possibly including one or more BSs. When the PBS includes a plurality of BSs, a BS handover attempt may be sequentially performed according to predicted priorities, until the handover is successful or a preset upper limit of the number of BSs is reached.

The target base station (TBS) refers, in some embodiments, to a BS accessed after the UE performs the BS handover successfully. When a traditional method is employed for the BS handover (or the RRC re-establishment when the RLF is triggered), the TBS refers to a BS accessed after the traditional BS handover process; and when the method in some embodiments of the present disclosure is employed for the BS handover, the TBS refers to a BS to which the UE hands over actually in the predicted PBS(s). In other embodiments, the TBS is a BS re-accessed after the UE performs beam failure recovery successfully, i.e., it may also be the original serving base station.

### Predetermination of RLF/Handover and Target BS-Beam Prediction

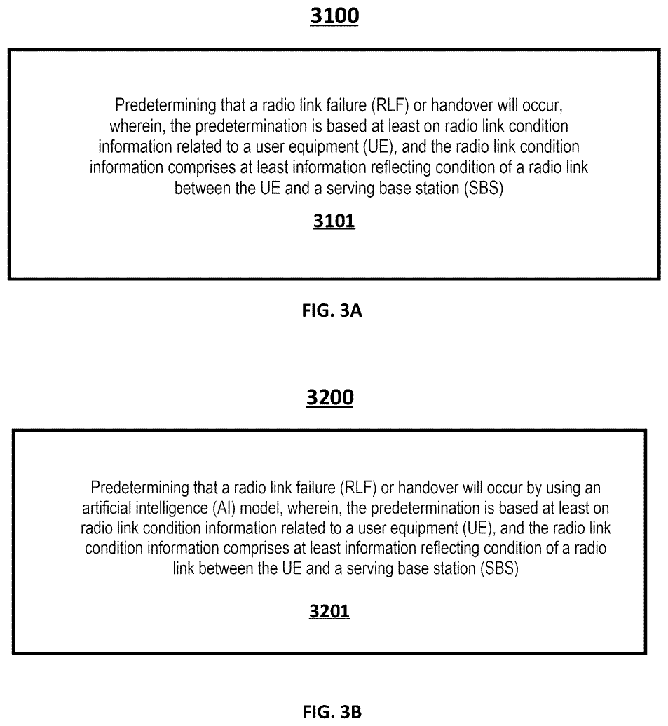

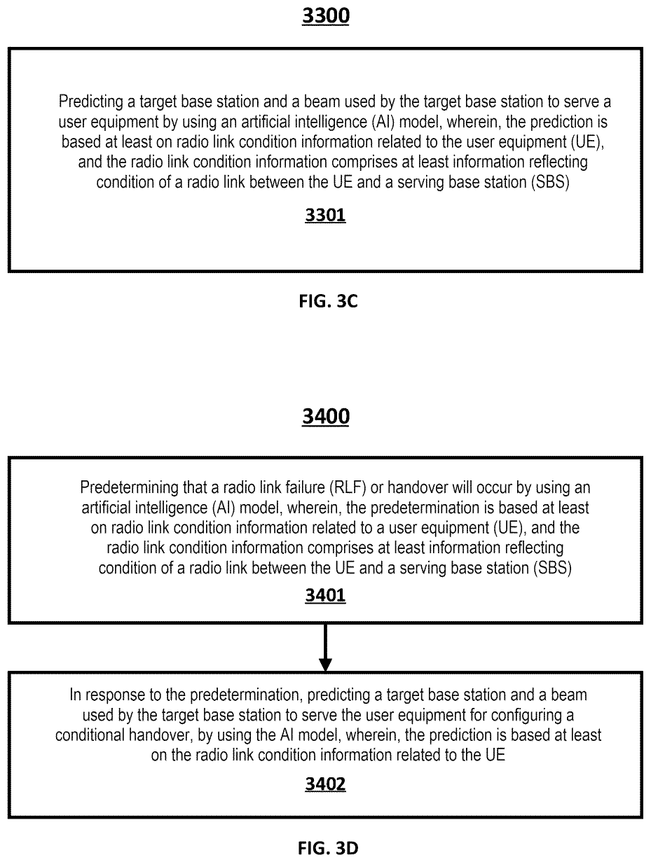

FIG. 3A is a flow diagram illustrating an exemplary method 3100 for radio communication according to an embodiment of the present disclosure.

As shown in FIG. 3A, the method 3100 for radio communication may comprise an operation 3101, at which it is predetermined that a radio link failure (RLF) or handover will occur, wherein, the predetermination is based at least on radio link condition information related to a user equipment (UE), the radio link condition information comprising at least information reflecting condition of a radio link between the UE and a serving base station (SBS).

In some embodiments, the predetermination operation may be performed by the UE. The UE may make the predetermination on whether the RLF or handover will occur, according to statistical information of reception of downlink signals and a comparison with a preset threshold (the preset threshold is broader than a threshold related to the existing RLF event, A3 event, or the like).

In some embodiments, the predetermination operation may be performed by the serving base station. The serving base station may make the predetermination on whether the RLF or handover will occur according to statistical information of reception of uplink signals and a comparison with a preset threshold (the present threshold is broader than the threshold related to the existing RLF event, A3 event, or the like).

The statistical information may be statistics of signal intensities such as RSRP, RSRQ, and RSSI, or statistics of signal error rates such as BLER and BER.

In summary, the predetermination can be made in advance by setting a broader condition than the existing RLF event or A3 event.

In one aspect, the predetermining that the RLF or handover will occur may enable the UE to trigger corresponding candidate beam measurement in advance when it is still capable of data communication with the current serving base station, and report the measurement result to the current serving base station.

On the other hand, the candidate beam measurement can be made in advance, so that a measurement range can be increased, thereby improving the quality of the measurement result. In the case where the target BS-beam prediction is to be made subsequently, the high-quality candidate beam measurement result may provide a high-quality input to the target BS-beam prediction.

FIG. 3B is a flow diagram illustrating an exemplary method 3200 for radio communication according to an embodiment of the present disclosure.

As shown in FIG. 3B, the method 3200 for radio communication may comprise an operation 3201, at which it is predetermined that a radio link failure (RLF) or handover will occur by using an artificial intelligence (AI) model, wherein, the predetermination is based at least on radio link condition information related to a user equipment (UE), the radio link condition information comprising at least information reflecting condition of a radio link between the UE and a serving base station (SBS).

In some embodiments, the AI model may be arranged at the UE, and the UE may send to the serving base station, a predetermination result obtained by using the AI model or information related to the predetermination result (e.g., a predicted probability of occurrence of the RLF or handover).

In some embodiments, the UE may predict the probability of occurrence of the RLF or handover by using the AI model. When the probability of occurrence of the RLF or handover is greater than a preset threshold, the UE may predetermine that the RLF or handover will occur.

In other embodiments, the UE may also, by using the AI model, directly output a predetermination result, i.e., whether the RLF or handover will occur.

In other embodiments, the AI model may be arranged at the serving base station. The serving base station may predict the probability of occurrence of the RLF or handover by using the AI model, and compare the probability of occurrence of the RLF or handover with a preset threshold to predetermine whether the RLF or handover will occur.

In still other embodiments, the serving base station may directly output a predetermination result by using the AI model.

Since the AI model can establish a relation between a complex radio environment and a BS-beam handover, the AI-assisted predetermination of the RLF or handover allows accurately predetermining the occurrence probability and/or occurrence time, etc. of the RLF or handover in advance based on the radio link condition information related to the UE, and making a response early, better guaranteeing the stability of communication.

The predetermining that the RLF or handover will occur may enable the UE to trigger corresponding candidate beam measurement in advance when it is still capable of data communication with the current serving base station, and report the measurement result to the current serving base station. Moreover, the candidate beam measurement is performed in advance, so that a measurement range can be increased, thereby improving the quality of the measurement result. In the case where the target BS-beam prediction is to be made subsequently, the high-quality candidate beam measurement may provide a high-quality input to target BS-beam prediction.

FIG. 3C is a flow diagram illustrating an exemplary method 3300 for radio communication according to an embodiment of the present disclosure.

As shown in FIG. 3C, the method 3300 for radio communication may comprise an operation 3301, at which a target base station and a beam used by the target base station to serve the user equipment are predicted by using an artificial intelligence (AI) model, wherein, the prediction is based at least on radio link condition information related to the user equipment (UE), the radio link condition information comprising at least information reflecting condition of a radio link between the UE and a serving base station (SBS).

The AI model may be arranged at the serving base station. In some embodiments, the AI model may be used for assisting the serving base station in predicting a target base station and a beam used by the target base station to serve the user equipment, e.g., for configuring a conditional handover.

The operation 3201 may be performed in response to a predetermination that an RLF or handover will occur. The predetermination that the RLF or handover will occur may be obtained according to various methods described in conjunction with FIG. 3A or 3B.

A relation between a complex radio environment and the BS-beam handover can be accurately established by using the AI model, so that the AI-assisted BS-beam prediction can allow accurately predicting the target base station and the serving beam used by the target base station for the UE in advance based on the radio link condition information related to the UE, thereby better guaranteeing the stability of communication.

FIG. 3D is a flow diagram illustrating an exemplary method 3400 for radio communication according to an embodiment of the present disclosure.

As shown in FIG. 3D, the method 3400 for radio communication may comprise an operation 3401, at which it is predetermined that a radio link failure (RLF) or handover will occur by using an artificial intelligence (AI) model, wherein, the predetermination is based at least on radio link condition information related to a user equipment (UE), the radio link condition information comprising at least information reflecting condition of a radio link between the UE and a serving base station (SBS).

As shown in FIG. 3D, the method 3400 for radio communication may comprise an operation 3402, at which in response to the predetermination, a target base station and a beam used by the target base station to serve the user equipment are predicted by using the AI model, for configuring a conditional handover, wherein, the prediction is based at least on the radio link condition information related to the UE.

The AI model is an AI-based system model that can realize the RLF or handover predetermination as well as the target BS-beam prediction. The AI model may include one or more AI sub-models arranged at the UE and the serving base station. In some embodiments, the AI model may include only one or more AI sub-models arranged at the serving base station.

The AI sub-model arranged at the UE may be used for the predetermination of the RLF or handover. The AI sub-model arranged at the serving base station may be used for the predetermination of the RLF or handover and/or the prediction of the target BS-beam.

An output of the AI sub-model for the predetermination of the RLF or handover may comprise at least one of an occurrence probability or occurrence time of the RLF or handover. In some embodiments, an output of the AI sub-model for the predetermination of the RLF or handover may be the predetermination result of the RLF or handover, i.e., whether the RLF or handover will occur. An output of the AI sub-model for the prediction of the target BS-beam may comprise a predicted target base station-beam set.

An input to the predetermination of the RLF or handover and an input to the prediction of the target BS-beam may be the same or different. For example, an input to the prediction of the target BS-beam may include, in addition to an input to the predetermination of the RLF or handover, additional information on the radio link condition that is obtained by supplementary measurement or the like after the predetermination.

An output of the AI model may comprise the target base station-beam set which comprises one or more target base station-beam pairings, each pairing indicating one target base station and one beam used by the target base station to serve the user equipment that are predicted.

Only some embodiments according to the present disclosure have been illustrated above. Various other embodiments can be conceived by those skilled in the art in light of the teachings of this disclosure. For example, in the case of predetermining, by a UE or a serving base station, that an RLF or handover will occur, the serving base station may also perform configuration for performing a conditional handover or assisting beam recovery by using a traditional method according to measurement results of the serving base station and a neighboring base station that are reported by the UE, rather than performing handover configuration based on the BS-beam set predicted by using the AI model.

### BS-Beam Handover Joint Prediction Model

An AI-based model which may be used for performing predetermination of an RLF/handover and prediction of a target BS-beam is hereinafter referred to as a BS-beam handover joint prediction model. The BS-beam handover joint prediction model may comprise one or more AI sub-models. These AI sub-models may be deployed at a serving base station, or at a serving base station and a UE.

An input of each AI sub-model in the one or more AI sub-models comprised in the BS-beam handover joint prediction model comprises at least radio link condition information related to the UE.

An output of each AI sub-model for target BS-beam prediction in the BS-beam handover joint prediction model may comprise a target base station and its candidate beam set for serving the UE. An output of each AI sub-model for predetermination of an RLF/handover in the BS-beam handover joint prediction model may comprise an occurrence probability and/or occurrence time of the RLF or handover. In the case where the BS-beam handover joint prediction model is formed by only one AI sub-model, an output of the AI sub-model may include at least one of an occurrence probability, occurrence time of the RLF or handover, or a target BS-beam set.

The BS-beam handover joint prediction model of the present disclosure supports predicting the occurrence probability and occurrence time of the RLF/handover, etc. according to radio link information over a past period of time. Specifically, the input of the model may be radio link condition information over a past period of time, including but not limited to past periodic or aperiodic downlink beam measurement results (e.g., beam ID and RSRP, RSSI, etc. of the corresponding beam) of the UE for the serving BS and/or neighboring BS, CSI measurement (e.g., PMI, RI, CQI) for the serving BS, etc. The output thereof may include the occurrence probability of the RLF/handover, the occurrence time of the RLF/handover, the predicted BS-beam set, etc.

As an embodiment of the artificial intelligence model of the present disclosure, a recurrent neural network (RNN), such as a long short-term memory network (LSTM), may be specifically employed.

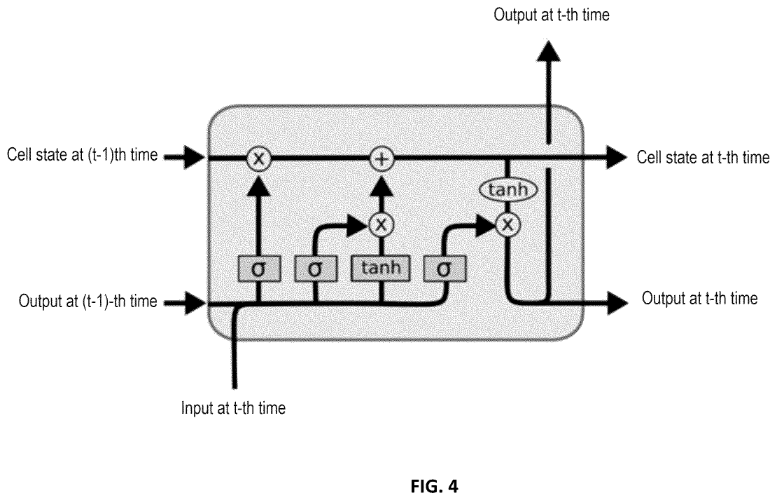

FIG. 4 is a schematic diagram illustrating a basic structure of an LSTM. As shown in FIG. 4, input information of the LSTM at a current time t includes an output of the LSTM at a previous time and an input of the LSTM at the current time. Therefore, the LSTM can sequentially learn radio link information over a past period of time to accurately model a motion state of a user.

The RLF or handover is often caused by user motion, for example, due to user motion, a direct path of a current serving base station is blocked, and the communication quality of the current serving base station is greatly reduced, so that an RLF occurs. Therefore, efficiently modeling and extracting the motion state of the user helps to predetermine the RLF or handover more accurately. Further, the radio link information of the user over the past period of time can represent a motion feature of the user, so that the motion feature of the user is extracted by using a neural network suitable for processing a time sequence, namely a recurrent neural network (including a long short-term memory network (LSTM) and the like).

An input of the LSTM may be radio link condition information related to the UE that is input in a form of a time sequence over a period of time (or a radio link condition feature extracted by preprocessing, according to the radio link condition information related to the UE that is input in a form of a time sequence over a period of time). The input may be in the form of the time sequence, including but not limited to: for radio link condition information measured at equal intervals in time, the input being radio link condition information which forms a sequence sequentially in chronological order; and for radio link condition information measured at non-equal intervals in time, the input being radio link condition information which forms a sequence sequentially in chronological order, as well as corresponding time information (e.g., normalized measurement intervals).

An output of the LSTM may be a prediction result that the RLF or handover will occur (or prediction features that the RLF or handover will occur, which form a prediction result after passing through an output layer), including but not limited to the occurrence probability, occurrence time of the RLF or handover, the handover target base station and beam, etc.

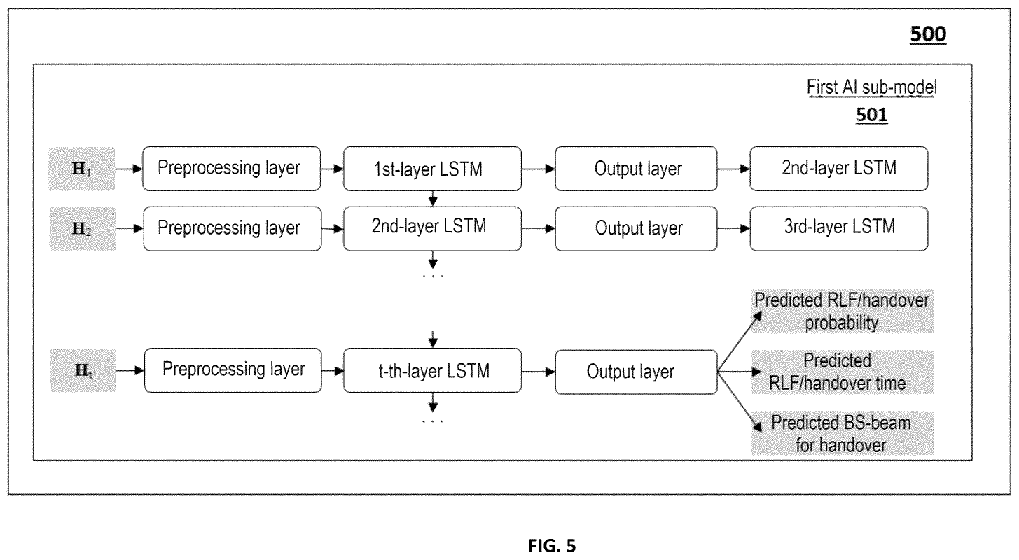

FIG. 5 is a schematic diagram illustrating a structure of an exemplary base station-beam handover joint prediction model 500, according to an embodiment of the present disclosure. In some embodiments, the base station-beam handover joint prediction model 500 may comprise a first AI sub-model 501 deployed at a serving base station.

As shown in FIG. 5, for the base station-beam handover joint prediction model 500 implemented by the LSTM structure, it is assumed that prediction is performed by using past periodic CSI measurement results H₁, H₂, . . . , Hₜ of the current serving base station (i.e. as an input of the AI model), where Hₜ represents a CSI measurement result in a t-th period. In an example, the CSI measurement result H is restored based on a downlink CSI measurement result that the UE measures a CSI-RS of the current serving base station and reports, for example, a downlink channel matrix restored according to a PMI and RI included in the CSI; in another example, particularly applied to a TDD system with reciprocity in uplink and downlink channels, the CSI measurement result is an uplink CSI measurement result obtained by measuring, by the current serving base station, an SRS sent by a UE, that is, an uplink channel matrix. After each piece of CSI is input, preliminary feature extraction is first made on the CSI by using a preprocessing layer, wherein an implementation of the preprocessing layer of the present disclosure comprises a convolutional neural network (CNN), a fully-connected neural network (FCNN) and the like. Then, feature extraction is made on the CSI sequence sequentially by using LSTM to model user motion information. Finally, by using an output layer, a final result is obtained, which may include a predicted RLF/handover probability, a predicted RLF/handover time, and a predicted target BS-beam.

When the predicted RLF/handover probability exceeds a certain preset threshold and an RLF/handover is determined, a target BS and beam for handover can be (but not limited to) directly predicted according to the output layer. In the embodiment of FIG. 5, one AI sub-model 501 is adopted, and after the RLF or handover is predetermined and before the target BS-beam is predicted, no additional measurement is performed, then the input to the determination of the handover event and the prediction of the handover BS-beam is consistent with the input to prediction of the handover probability in itself, the above plurality of predicted targets can be implemented by using one neural network structure, the neural network can use the same radio link condition information related to the UE as an input and finally output the plurality of targets at the output layer. The advantage of such design is that the overall computational overhead of the prediction model can be significantly reduced.

The implementation of the output layer in the embodiment of FIG. 5 is a fully-connected layer (assuming that an output of an LSTM is xt at a t-th time, the fully-connected layer can be written as yₜ=Wxt+bₜ, where W and b are a weight matrix and a bias vector, yₜ is an output of the fully-connected layer).

Specific values of the weight matrix W and the bias vector b are learned by the AI model, but dimensions thereof generally can be pre-defined, and conform to a matrix operation dimension constraint for outputting y=Wx+b, where x is an output eigenvector of the LSTM layer. Assuming that an eigenvector dimension output by a t-th layer of LSTM is Nₜ×1, and an output is a probability p (scalar) of predetermining whether a handover event occurs, the dimension of the weight matrix W corresponding to the output is Nₜ×1 and the dimension of the bias vector is 1×1. Accordingly, if the output is the base station-beam probability for the handover and there are M candidate base station-beam combinations in total so that the output is a vector of M×1, the dimension of the weight matrix W corresponding to the output is Nₜ×M, and the dimension of the bias vector is M×1.

For the case where different results are output simultaneously by the AI sub-model, a plurality of output layers are usually used, each output layer corresponding to a different result. For example, when the handover probability, handover time and BS-beam set are output simultaneously, three output layers may be used, an input of each output layer being an output eigenvector of an LSTM, assuming that a dimension of an eigenvector output by a t-th layer LSTM is Nₜ×1. For a handover probability output (scalar), dimensions of the weight matrix W and the bias vector b are Nₜ×1, 1×1, respectively; for a handover time output (scalar), dimensions of the weight matrix W and the bias vector b are Nₜ×1, 1×1, respectively; and for a BS-beam set output, assuming that there are M candidate base station-beam combinations in total so that the output is a vector of M×1, a dimension of the weight matrix W corresponding to the output is Nₜ×M, and a dimension of the bias vector is M×1.

The output layer itself is part of the AI model, and its training process is consistent with the training of the whole AI model, i.e. based on a loss between the prediction result and a real label (the smaller the difference between the prediction result and the real label, the smaller the loss; and the larger the difference between the prediction result and the real label, the larger the loss), a parameter of the output layer is optimized by using, for example, a gradient back propagation algorithm.

The exemplary CSI-based model input as described above can also be replaced with a beam measurement result, for example, a beam ID of the serving base station measured every period and an index such as RSRP and BLER reflecting intensity or quality of the beam. In addition, the model input may also be an ID of a neighboring cell for which a neighboring base station provides coverage that is measured in a mobility measurement process, a neighboring cell beam ID, and an index such as RSRP reflecting intensity of the neighboring cell beam. In other embodiments, input data to the model 500 may include real-time geographic environment and radio environment information in at least one of a high-precision map or electromagnetic map, a location and motion feature of the UE, or data of a sensor including at least one of an accelerometer or barometer of the UE, wherein the data in essence may also reflect radio link condition related to the UE.

As shown in FIG. 5, an input of the base station-beam handover joint prediction model 500 at a time t may be radio link condition information related to the UE at the time, and an output at the time may include the predicted RLF/handover probability, the predicted RLF/handover time, and/or the predicted target BS-beam set.

In some embodiments, the serving base station may predetermine whether an RLF or handover will occur according to the output. For example, the serving base station may compare the predicted RLF/handover probability with a preset threshold to predetermine whether an RLF or handover will occur. In the case of predicting that the RLF or handover will occur, the serving base station may use the predicted BS-beam set for a subsequent handover.

In some embodiments, the predicted BS-beam set may include a plurality of BS-beams. In some embodiments, the prediction result may provide the UE with a BS handover process having priorities. For example, predicted priorities of BS handovers for the UE may be BS 2, BS 3, BS 1, BS 4, then the UE can preferentially access the BS 2 and preferentially access a beam with higher prediction quality within the BS 2. When the handover for the BS 2 fails, a handover attempt for the BS 3 is continued according to the priorities, and so on, until the handover is successful or a preset BS handover overhead upper limit is reached.

Those skilled in the art can appreciate that the output layer of the base station-beam handover joint prediction model 500 (the first AI sub-model 501) may be designed as needed. In some embodiments, the output may be a predetermination result for the RLF or handover and/or a predicted occurrence time of the RLF or handover, as well as a predicted BS-beam set.

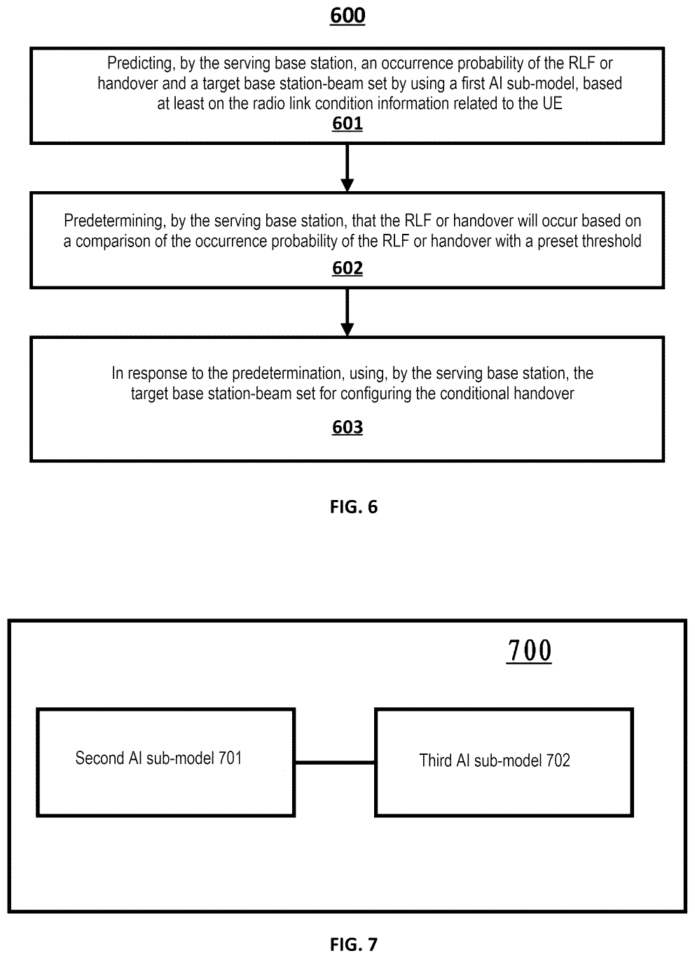

FIG. 6 is a flow diagram illustrating an exemplary method 600 for radio communication according to an embodiment of the present disclosure.

The method may be applied to the case where the base station-beam handover joint prediction model described in conjunction with FIGS. 4 and 5 includes the first sub-AI model deployed at the serving base station. In this case, one trained AI sub-model can complete the operations of prediction of the occurrence probability of the RLF/handover and prediction of the target BS-beam. The serving base station can complete the RLF/handover predetermination and the target BS-beam prediction by using the AI sub-model. In some embodiments, the AI sub-model may also predict the occurrence time of the RLF/handover.

As shown in FIG. 6, the method 600 may comprise an operation 601, at which the serving base station predicts an occurrence probability of the RLF or handover and a target base station-beam set by using a first AI sub-model, based at least on the radio link condition information related to the UE.

The radio link condition information related to the UE may comprise at least one of radio link condition information related to the UE received from the UE or radio link condition information related to the UE measured by the serving base station.

The method 600 may also comprise an operation 602, at which the serving base station predetermines that the RLF or handover will occur, based on a comparison of the occurrence probability of the RLF or handover with a preset threshold.

The method 600 may also comprise an operation 603, at which in response to the predetermination, the serving base station uses the target base station-beam set for configuring a conditional handover.

In some embodiments, the serving base station may directly output the predetermination result for the RLF or the handover by using the first AI sub-model. In some embodiments, the first AI sub-model may also indicate a predicted occurrence time of the RLF or handover. By using the trained AI model (which can accurately model the relation between the radio environment feature of the SBS and the BS-beam handover), accurate predetermination for the RLF or handover, as well as accurate prediction for the target BS-beam, can be achieved.

By providing one AI sub-model at the serving base station to implement both predetermination for the RLF/handover and prediction for the target BS-beam, thereby enabling a plurality of prediction outputs by using one neural network structure, the overall computational overhead of the prediction model can be reduced.

FIG. 7 is a diagram illustrating a structure of an exemplary base station-beam handover joint prediction model 700 according to an embodiment of the present disclosure.

As shown in the figure, the base station-beam handover joint prediction model 700 may comprise a second AI sub-model 701 and a third AI sub-model 702.

The second AI sub-model 701 and the third AI sub-model 702 may both be deployed on the serving base station.

Internal structures of the second AI sub-model 701 and the third AI sub-model 702 each may be similar to the structure of the first AI sub-model 501 shown in FIG. 5.

An input of the second AI sub-model 701 may be the radio link condition information related to the UE, while an output thereof may be the occurrence probability of the RLF or handover.

The serving base station may predetermine that the RLF or handover is imminent based on the occurrence probability of the RLF or handover predicted by the second AI sub-model 701, and perform collection of additional radio link condition information related to the UE.

It can be understood that, in some embodiments, the second sub-model 701 may also directly output the predetermination result of the RLF or handover. In some embodiments, the second sub-model 701 may also output a predicted occurrence time of the RLF or handover.

The radio link condition information related to the UE, together with the additional radio link condition information collected after the predetermination, are included in an input of the third AI model 702, and an output of the third AI model 702 may be the target BS-beam set.

The radio link condition information related to the UE and the additional radio link condition information collected after the predetermination may be different types of information.

For example, the radio link condition information related to the UE for the predetermination may include a mobility measurement result, real-time geographical environment and radio environment information including at least one of a high-precision map or an electromagnetic map, a location and motion feature of the UE, or data of a sensor including at least one of an accelerometer or barometer of the UE, etc., while the additional radio link condition information collected after the predetermination for the third AI sub-model may include CSI.

It can be understood that when the second AI sub-model and the third AI sub-model are trained, training data used may also be different. For example, the training data for training the second AI sub-model may include a mobility measurement result, real-time geographic environment and radio environment information including at least one of a high-precision map or electromagnetic map, a location and motion feature of the UE, or data of a sensor including at least one of an accelerometer or barometer of the UE, while the training data for training the third AI sub-model may also include CSI.

It can be appreciated that in some embodiments, the radio link condition information related to the UE for the predetermination may include CSI, while the additional radio link condition information collected after the predetermination for the third AI sub-model may include a mobility measurement result, real-time geographical environment and radio environment information including at least one of a high-precision map or electromagnetic map, a location and motion feature of the UE, and data of a sensor including at least one of an accelerometer or barometer of the UE. In the training phase, the training data for training the second AI sub-model and the third AI sub-model may also be different accordingly.

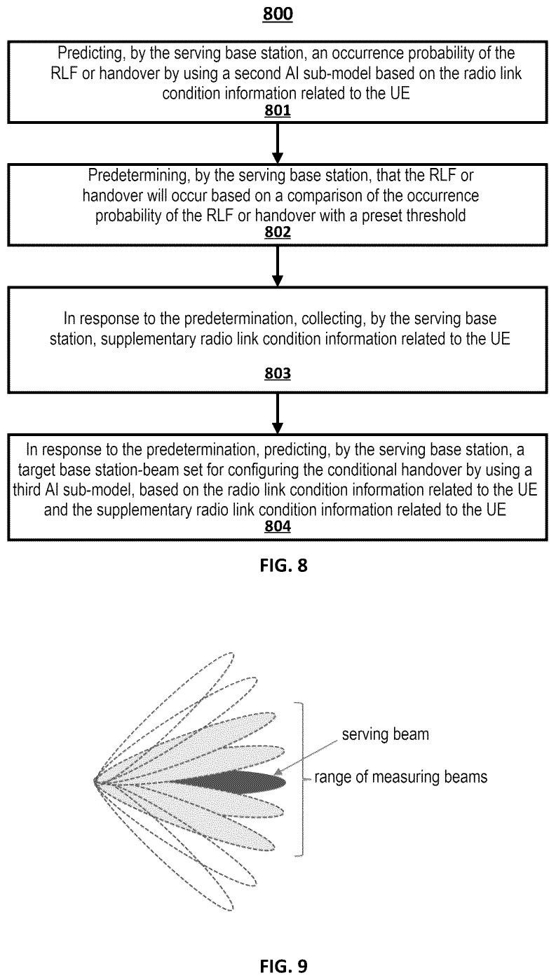

FIG. 8 is a flow diagram illustrating an exemplary method 800 for radio communication according to an embodiment of the present disclosure.

The method may be applied to the case where the base station-beam handover joint prediction model 700 described in conjunction with FIG. 7 includes two AI sub-models (i.e., the second AI sub-model 701 and the third AI sub-model 703) deployed at the serving base station. In this case, the trained two AI sub-models may implement the operations of RLF/handover probability prediction and target BS-beam prediction, respectively. The serving base station may complete the RLF/handover predetermination by using the second AI sub-model 701, and complete the target BS-beam prediction by using the third AI sub-model 702.

As shown in FIG. 8, the method 800 may comprise an operation 801, at which the serving base station predicts, based on the radio link condition information related to the UE, an occurrence probability of the RLF or handover by using a second AI sub-model, e.g., the second AI sub-model 701 of FIG. 7.

The method 800 may also comprise an operation 802, at which the serving base station predetermines that the RLF or handover will occur based on a comparison of the occurrence probability of the RLF or handover with a preset threshold.

The method 800 may also comprise an operation 803, at which in response to the predetermination, the serving base station may collect supplementary radio link condition information related to the UE. As described above, the supplementary radio link condition information related to the UE collected after the predetermination may be a same type of information as or a different type of information from the radio link condition information related to the UE collected before the predetermination.

The method 800 may also comprise an operation 804, at which in response to the predetermination, the serving base station predicts, based on the radio link condition information related to the UE and the supplementary radio link condition information related to the UE, a target base station-beam set for configuring a conditional handover, by using a third AI sub-model, such as the third AI sub-model 702 of FIG. 7.

It can be understood that, in some embodiments, the second AI sub-model 701 may directly output the predetermination result of the RLF or handover at the operation 801. In this case, the operation 802 may be omitted.

After the RLF or handover is predetermined, an additional measurement event is performed for the handover, and prediction of the BS-beam is performed based on the additional measurement result, which may allow the predicted BS-beam set to be more accurate. This is particularly advantageous for the case where the UE is in a fast motion process.

FIGS. 5-8 above all describe the case where the AI sub-model included in the base station-beam handover joint prediction model is deployed only at the serving base station. In some cases, the AI sub-model may also be deployed at the UE, as part of the base station-beam handover joint prediction model.

In some embodiments, an AI sub-model (referred to herein as a fourth AI sub-model) may be deployed at the UE. A structure of the fourth AI sub-model may be similar to that of the first AI sub-model 501 shown in FIG. 5, which will not be repeated here.

The UE may predict an occurrence probability of the RLF or handover by using the fourth AI sub-model based on the radio link condition information related to the UE. In some embodiments, the fourth AI sub-model may also output an occurrence time of the RLF or handover. The UE may send the predicted occurrence probability and/or occurrence time of the RLF or handover to the serving base station.

In some embodiments, the serving base station may include the occurrence probability of the RLF or handover predicted by the UE that is received from the UE in an input to its own prediction of the occurrence probability of the RLF or handover and of the target base station-beam by using the AI sub-model. For example, in the methods of FIGS. 6 and 8, the occurrence probability of the RLF or handover predicted by the UE that is received by the serving base station from the UE, may be included in the radio link condition information related to the UE of the operations 601, 801, or 804, as the input of the corresponding AI sub-model.

By arranging the fourth AI sub-model at the UE, the RLF or handover predetermination result at the UE side can be obtained, as part of the input information of the predetermination of the RLF or handover and/or the prediction of the target BS-beam at the serving base station, which on one hand can reduce the amount of information transmitted by the UE to the serving base station, and on the other hand can improve the accuracy of the predetermination and/or prediction at the serving base station.

In other embodiments, the base station-beam handover joint prediction model may comprise an AI sub-model (referred to as a fifth AI sub-model) deployed at the UE and an AI sub-model (referred to as a sixth AI sub-model) deployed at the serving base station. Structures of the fifth and sixth AI sub-models may be similar to that of the first AI sub-model 501 shown in FIG. 5.

In this case, the UE may predict an occurrence probability and/or occurrence time of the RLF or handover by using the fifth AI sub-model based at least on the radio link condition information related to the UE. The UE may send the predicted occurrence probability and/or occurrence time of the RLF or handover to the serving base station. The serving base station may predetermine that the RLF or handover will occur based on a comparison of the predicted occurrence probability of the RLF or handover received from the UE with a preset threshold. In response to the predetermination, the serving base station may predict a target base station-beam set for configuring a conditional handover by using the sixth AI sub-model, based at least on the radio link condition information related to the UE.

As described above, the AI sub-model deployed at the UE side itself may predict the probability and time of the RLF/handover according to channel quality information of the serving BS and/or neighboring BS over a past period of time, and when the predicted probability is greater than a certain preset threshold, predetermine the event occurrence, and feedback one or more of an event type, the predicted probability and time of the RLF/handover-related event to the serving BS. The serving BS can perform predetermination by directly using the probability fed back by the UE; and may also use this probability as an input to further predict the occurrence probability of the RLF/handover and the target BS-beam handover.

In some embodiments, the fifth AI sub-model may also directly output the predetermination result and/or occurrence time of the RLF or handover. The sixth AI sub-model may start predicting the target BS-beam set in response to the predetermination result from the fifth AI sub-model.

The prediction at the UE side can reduce the overhead by that the UE feeds back the radio link condition information to the serving BS. Taking the above embodiment as an example, the UE may not necessarily feedback the channel quality information of the serving BS and the neighboring BS over a past period of time, but only feedback the prediction probability, or even only the predetermination result.

The implementation of the predetermination of the RLF or handover and the prediction of the target BS-beam by one or more AI sub-models has been exemplified above. Various variants may be implemented by those skilled in the art in light of the teachings of this disclosure. For example, in some embodiments, only the AI sub-model that implements the predetermination of the RLF or handover may be used, while the conditional handover or beam recovery after the predetermination is still performed according to a traditional method. In some embodiments, only the AI sub-model that implements the target BS-beam prediction may be used, while the AI assistance is not used for the predetermination of the RLF or handover.

In some embodiments, the handover or RLF-related event may include an A3 event. The A3 event defined in the 3GPP NR standard refers to that: within a preset time threshold, a difference between the communication quality of the SBS and the communication quality of the neighboring base station meets a preset relationship. Assuming that RSRP of the SBS is P_{S} and RSRP of a certain neighboring base station is P_{N}, they satisfy

P_{N}>P_{S}+Pₜₕ

where Pₜₕ is a preset threshold, usually a positive value or a negative value with a small absolute value, indicating that communication quality of the neighboring base station is better than or close to that of the SBS.

In some embodiments, for the A3 event, the radio link condition information related to the UE may include information reflecting radio link condition between the UE and the serving base station as well as the neighboring base station. A traditional A3 event is triggered by the UE measuring the communication quality of the serving BS and the neighboring BS. According to the embodiments of the present disclosure, an occurrence probability and an occurrence time of the A3 event can be predicted according to the radio link information over a past period of time. The prediction model may predict the occurrence probability and the occurrence time of the A3 event according to the radio link information of the serving BS and/or neighboring BS over a past period of time. When the predicted probability is greater than a certain threshold, it is predetermined that the A3 event occurs.

The predetermination of the A3 event occurrence may be used for further predetermination of the RLF or handover. In some embodiments, the predetermination of the RLF/handover may be activated according to the predetermination that the A3 event is imminent. An input to the AI model for the predetermination of the RLF/handover may include the predicted probability and/or predicted occurrence time of the A3 event.

In still other embodiments, at least one of the RLF or handover prediction or target BS-beam prediction of the embodiments of the present disclosure may be performed based on a traditional A3 event. For example, when an A3 event is triggered, the UE may send to the SBS, a communication quality measurement report (RSRP or reference signal received quality (RSRQ)) of the SBS and neighboring base stations. The SBS may predict a target base station and its serving beam according to the measurement report and other radio link-related information (e.g., CSI measurement, beam measurement, and other results of the UE over a past period of time). In other words, the measurement result after the A3 event is triggered may be used as part of the radio link condition information related to the UE, thereby serving as at least part of an input to the target BS-beam prediction.

### Radio Link Condition Information

In some embodiments, the radio link condition information related to the UE may include, in addition to the information reflecting condition of a radio link between the UE and the serving base station, information reflecting condition of a radio link between the UE and one or more neighboring base stations.

In some embodiments, the radio link condition information related to the UE may include radio link condition information measured by the UE, or radio link condition information measured by the serving base station. The serving base station may, from the UE, receive radio link condition information measured by the UE.

In some embodiments, the radio link condition information related to the UE may include, but is not limited to: a beam measurement result, a CSI measurement result, a mobility measurement result, real-time geographic environment and radio environment information including at least one of a high-precision map or an electromagnetic map, a location and motion feature of the UE, and data of a sensor including at least one of an accelerometer or barometer of the UE. The beam measurement result includes, but is not limited to, a BFR measurement result.

Target handover prediction for the base station and beam depends on the user location and the radio environment. The location and motion feature of the UE, radio link measurement result, sensor information (e.g., an accelerometer reflecting acceleration, a barometer reflecting altitude, etc.) can all reflect information of a current or future location of the user. The high-precision map and the electromagnetic map (mapping between different locations and radio link conditions, such as mapping between different locations and CSI) can reflect radio environment information. Those skilled in the art can appreciate that, any information related to the condition of the radio link of the UE that can facilitate the determination of the UE location and radio environment can be included in the radio link condition information related to the UE.

When a primary cell BS and a secondary cell BS serve the UE simultaneously, measurement results of the primary cell and the secondary cell can both be taken as a prediction input, i.e. the radio link condition information related to the UE.

In some embodiments, BFR measurement may be triggered when a preset communication quality threshold is not met and/or when it is predetermined that an RLF/handover will occur. A communication quality threshold Th₁ for triggering the BFR measurement and a BFR success threshold Th₂ candidate set may be configured by RRC. The serving base station may issue the above threshold set to the UE through an RRC Reconfiguration message, and the UE configures the thresholds according to the candidate set.

The communication quality threshold Th₁ may be a threshold by which basic communication requirements can be guaranteed, but there is a potential for an RLF or handover. For example, the RSRP threshold can support basic communication requirements, but cannot support a high speed service.

When a beam reaching the BFR success threshold Th₂ is found, it is considered that a subsequent BFR will be successful, without performing BS-beam handover joint prediction.

The BFR measurement triggered by predetermining, by the SBS, that the RLF/handover will occur will be used for supporting the prediction of the target BS-beam.

The BFR measurement according to the embodiment of the present disclosure starts up earlier than the traditional BFR measurement, and therefore, an additional beam measurement may be included, thereby increasing a success probability of finding a better beam for BFR while collecting a reliable prediction input.

In some embodiments, adjacent beam measurement may be performed, as shown in FIG. 9. In the adjacent beam measurement, a set of beams adjacent to the current serving beam in angle is measured. As shown in FIG. 9, beams that can be measured include a serving beam and beams adjacent to the serving beam. This provides an additional beam measurement compared to the traditional BRF measurement.

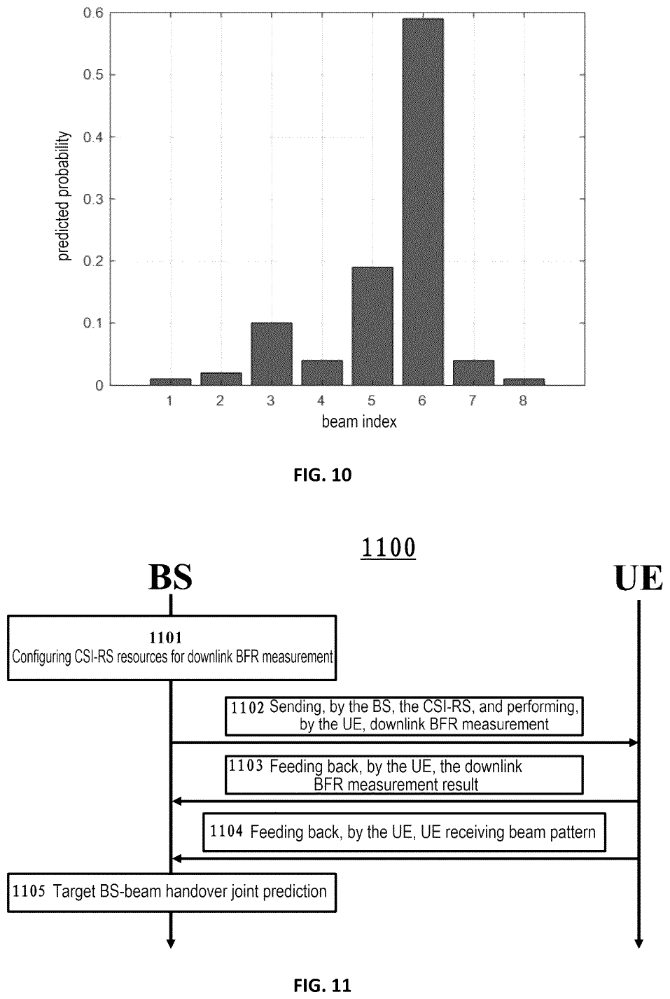

In other embodiments, beam measurement based on probability priorities may be performed, as shown in FIG. 10. In the beam measurement based on the probability priorities, a certain number of beams are selected for the measurement in descending order of predicted probabilities that each beam becomes a target beam. The method can be based on the BFR process assisted by deep learning, namely the probability that each candidate beam becomes the target beam is predicted by a deep learning model, which reflects the priority of the beam measurement. The serving base station may maintain its own optimal beam by using an AI model (referred to as a seventh AI sub-model). In the training phase, its input may be beam measurement information (e.g., RSRP) of the serving base station itself over a past period of time, and labels may be current and future optimal beam indices (obtained by a traditional beam management method), whereby the model is trained; when the training is ended and the current and future optimal beam indexes are predicted, the model output may be generally the probabilities that the candidate beams become the optimal beam. A beam with a highest predicted probability is selected as a predicted optimal beam. The predicted probability information may reflect the priority of the beam quality, i.e. the higher the probability, the better beam quality is considered, so that prioritized measurements may be performed in descending order of the probabilities. As shown in FIG. 10, it is possible to measure a beam 6 first, then a beam 5, and then a beam 3, and so on.

In some embodiments, both the adjacent beam measurement and the probability priority-based beam measurement may be performed.

FIG. 11 is a flow diagram illustrating an exemplary method 1100 for BS-beam handover joint prediction based on downlink BFR measurement according to an embodiment of the present disclosure.

As shown in FIG. 11, the method 1100 may comprise an operation 1101, at which the BS configures CSI-RS resources for downlink BFR measurement.

The method 1100 may further comprise an operation 1102, at which the BS sends a CSI-RS and the UE performs downlink BFR measurement.

For example, when in the BFR, a beam that meets a preset communication quality requirement of the UE is not found, operations 1103-0015 are performed.

The method 1100 may further comprise an operation 1103, at which the UE feeds back the downlink BFR measurement result to the BS.

The method 1100 may also comprise an operation 1104, at which the UE feeds back a UE receiving beam pattern to the BS.

The method 1100 may further comprise an operation 1105, at which the BS performs BS-beam handover joint prediction.

In this embodiment, the beam measurement result may include the downlink BFR measurement result and the UE receiving beam pattern. The beam measurement result may be included in the radio link condition information related to the UE for the BS-beam handover joint prediction. Based at least on the radio link condition information, the predetermination of the RLF or handover and the prediction of the target BS-beam may be performed, as described above.

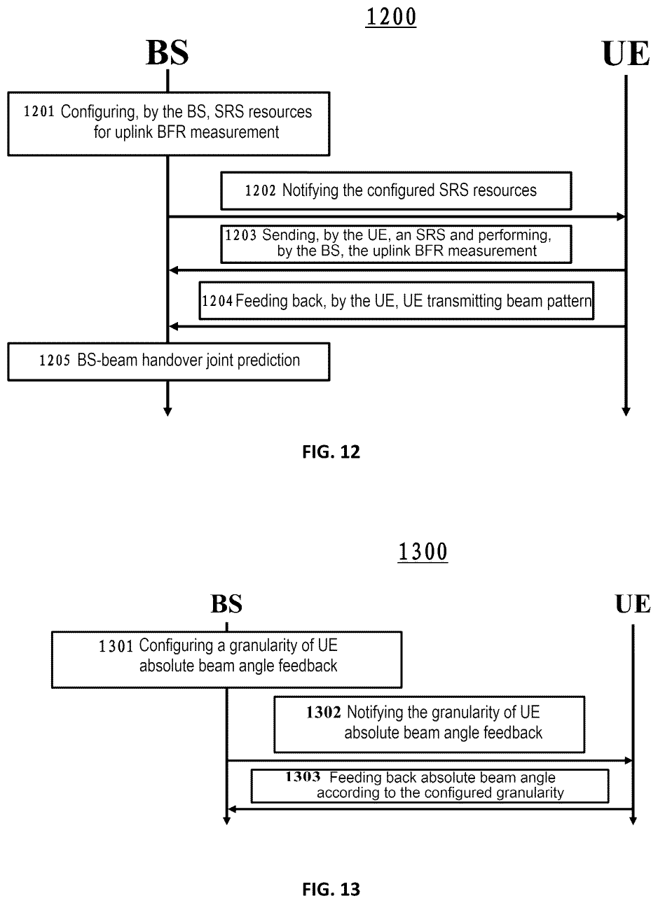

FIG. 12 is a flow diagram illustrating an exemplary method 1200 for BS-beam handover joint prediction based on uplink BFR measurement according to an embodiment of the present disclosure.

As shown in FIG. 12, the method 1200 may comprise an operation 1201, at which the BS configures SRS resources for uplink BFR measurement.

The method 1200 may comprise an operation 1202, at which the BS notifies the UE of the configured SRS resources.

The method 1200 may comprise an operation 1203, at which the UE sends an SRS and the BS performs the uplink BFR measurement.

Operations 1204-1205 are performed, for example, when in the BFR measurement, a beam that meets a preset communication quality requirement of the BS is not found.

The method 1200 may comprise an operation 1204, at which the UE feeds back a UE transmitting beam pattern to the BS.

The method 1200 may comprise an operation 1205, at which the BS performs BS-beam handover joint prediction.

In this embodiment, the beam measurement result may include the uplink BFR measurement result and the UE transmitting beam pattern. The beam measurement result may be included in the radio link condition information related to the UE for the BS-beam handover joint prediction. Based at least on the radio link condition information, the predetermination on the RLF or handover and the prediction of the target BS-beam may be performed, as described above.

In some embodiments, to improve the BS-beam handover joint prediction performance, the present disclosure contemplates an improved UE-side beam pattern feedback method, which can feed back UE-side beam absolute angle information. FIG. 13 is a flow diagram illustrating an exemplary UE-side beam pattern feedback method 1300 according to an embodiment of the present disclosure.

As shown in FIG. 13, the method 1300 may comprise the following operations:

operation 1301, at which the BS configures a granularity of UE absolute beam angle feedback.

Operation 1302, at which the BS notifies the UE of the granularity of UE absolute beam angle feedback.

Operation 1303, at which the UE feeds back an absolute beam angle to the BS according to the configured granularity.

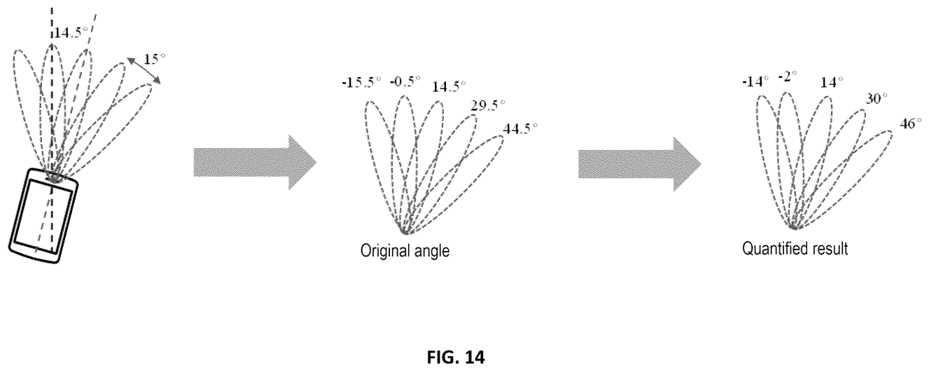

FIG. 14 illustrates a UE-side beam absolute angle calculation example according to an embodiment of the present disclosure.

As shown in FIG. 14, a UE rotation angle is θ_{UE}=14.5°, and a UE-side relative beam angle is θ_{UE,beam}={−30°,−15°,0°,15°,30° }, then a UE-side absolute beam angle is θ=θ_{UE}+θ_{UE,beam}={−15.5°,−0.5°,14.5°,29.5°,44.5° }. Assuming that the BS sets quantized feedback with a feedback interval of −90° to 90° and a granularity of 4° (i.e. sampling points are {−90°,−86°, . . . ,86°,90°}), a quantized UE-side absolute beam angle feedback is {−14°,−2°,14°,30°,46°}.

Performing the UE-side absolute beam angle feedback is to improve the BS-beam handover joint prediction performance, because the model needs to more accurately model the radio environment around the BS and the UE to infer the UE location feature from the radio link information.

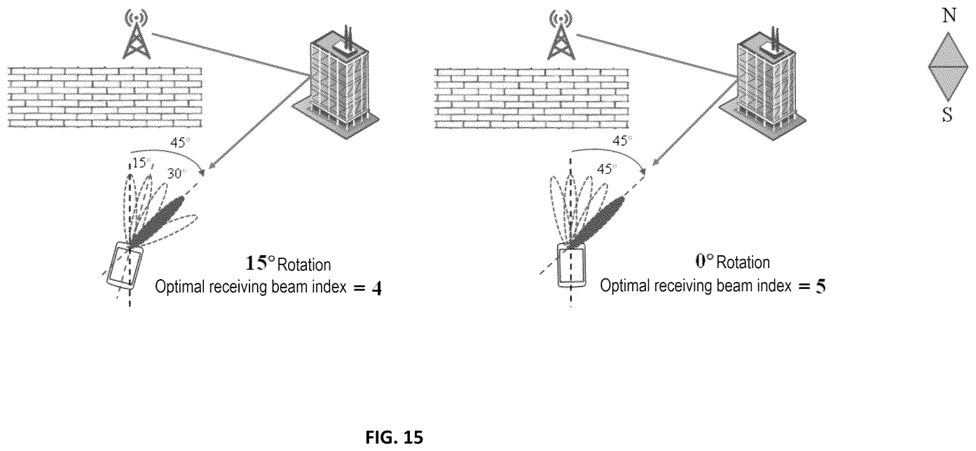

FIG. 15 illustrates an effect of UE's own rotation on a UE beam angle. As shown in FIG. 15, for the BS, its beam direction is fixed, so that measurement results corresponding to different beams can accurately represent a radio environment around the BS. However, for the UE, its beam direction is affected by the rotation angle of the UE itself. When the UE has different rotation angles, absolute angles corresponding to the same beam are different, so that the radio environment around the UE cannot be accurately modeled by measurement results for the same beam. In order to solve the problem, the present disclosure proposes that the UE feeds back absolute angle information of the beam to the BS, so that a prediction model deployed in the BS can extract a radio environment feature around the UE according to the absolute angle information of the beam and the measurement result, thereby improving prediction performance.

In some embodiments, a method of reducing UE-side beam absolute angle information feedback overhead may be considered, for example, a method of feeding back absolute angle information may include, but is not limited to: (1) the UE feeding back the rotation angle of the UE itself and the relative beam angle information; (2) the UE feeding back a set of calculated significant absolute angles (e.g., several absolute angles with highest receiving power), and so on.

The absolute angle feedback method according to the embodiment of the present disclosure helps to accurately model the radio environment around the UE to improve the prediction performance. By feeding back the absolute angle at a certain granularity, the overhead of the UE absolute beam angle feedback may be reduced.

### OBS-Beam Handover

As described above, the target BS-beam set predicted by the base station-beam handover joint prediction model according to the embodiment of the present disclosure may be used for a subsequent handover, such as a conditional handover.

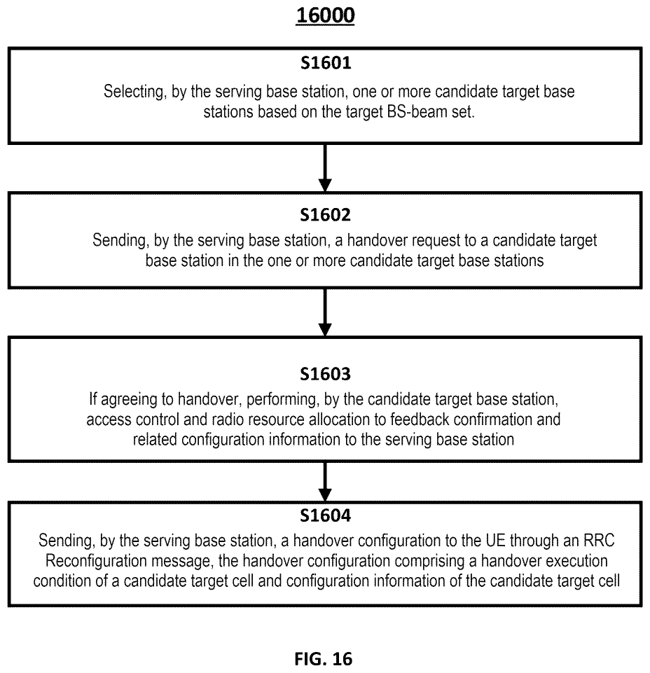

FIG. 16 is a flow diagram illustrating a base station-beam handover method 16000 according to an embodiment of the present disclosure. As shown in FIG. 16, the method 16000 may comprise an operation S1601, at which one or more candidate target base stations are selected by the serving base station based on the target BS-beam set. Preferably, a plurality of candidate target base stations are selected, thereby improving the UE handover success rate.

The method 16000 may also comprise an operation S1602, at which a handover request is sent by the serving base station to a candidate target base station in the one or more candidate target base stations.

The method 16000 may further comprise an operation S1603, at which if agreeing to handover, the candidate target base station performs access control and radio resource allocation, feedback confirmation and related configuration information to the serving base station.

The method 16000 may further comprise an operation S1604, at which a handover configuration is sent by the serving base station to the UE through an RRC Reconfiguration message, the handover configuration comprising a handover execution condition of a candidate target cell and configuration information of the candidate target cell that comprises target beam information.

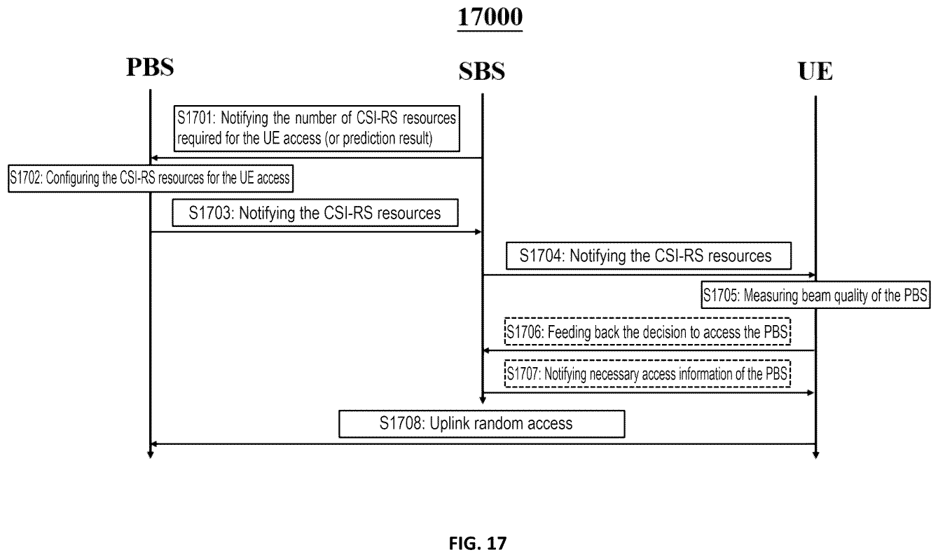

FIG. 17 is a flow diagram illustrating a base station-beam handover method 17000 according to an embodiment of the present disclosure.

As shown in FIG. 17, the method 17000 comprises the following operations:

operation S1701, at which the serving BS (SBS) notifies a predicted base station (PBS) of the number of CSI-RS or SSB resources required for the UE access, or notifies the PBS of the target BS-beam prediction result of the SBS for deciding, by the PBS itself, the number of configured CSI-RS or SSB resources. For example, the target BS-beam prediction result may include probabilities of respective candidate beams of the PBS predicted by the SBS.

S1702, at which the PBS configures the CSI-RS or SSB resources for the UE access, wherein the PBS sends a reference signal to the UE subsequently by using these CSI-RS or SSB resources in a predicted high-quality beam direction.

S1703, at which the PBS notifies the SBS of the configured CSI-RS or SSB resources (when the PBS does not configure the CSI-RS or SSB resources, the PBS does not provide the access service for the UE).

S1704, at which the SBS notifies the UE of the CSI-RS or SSB resources configured by the PBS. Optionally, the SBS also notifies the UE of a predicted UE receiving beam direction corresponding to a PBS transmitting beam.

S1705, at which the UE measures beam receiving quality (whose index may include but is not limited to RSRP) of the PBS on the CSI-RS or SSB resources configured by the PBS.

S1706, at which the UE feeds back its decision to access the PBS to the SBS.

S1707, at which, when the UE decides to access the PBS, the SBS notifies the UE of necessary access information of the PBS, including but not limited to a physical cell identity (PCI) of the PBS and a master information block (MIB), through an RRC Reconfiguration message.

S1708, at which the UE sends an uplink random access request to the PBS.

In some embodiments, the step S1706 may not be necessarily performed, and the S1707 is incorporated into the step S1704. That is, at the S1704, the SBS also notifies the UE of the necessary access information of the PBS, including but not limited to the physical cell identity (PCI) of the PBS and the master information block (MIB), through the RRC Reconfiguration message. In this case, when the UE decides to access the PBS, the UE initiates an uplink random access request to the PBS.

Taking an RLF as an example, in a traditional RRC re-establishment process depending on SSB broadcast, the SSB itself includes information such as a cell ID (carried in a PSS/SSS, while the PSS/SSS has a synchronization function), and a MIB (carried in a PBCH) for access. However, when the handover is assisted by using the prediction result, the UE does not need to obtain the above information through the traditional process. By using the SBS as a medium for transferring the PBS access reference signal resource and information, the UE accessing the PBS is assisted; meanwhile, assuming that the neighboring BS is basically synchronous, the UE can directly receive the CSI-RS or SSB of the PBS, without performing a specialized synchronization process and a beam scanning process.

In some embodiments, when the PBS contains a plurality of BSs, the SBS may repeatedly perform the S1701-S1706 in descending order of predicted priorities of the PBS, until the UE decides to access the PBS or the number of the PBS it attempts to access reaches a preset upper limit.

### Training of BS-Beam Handover Joint Prediction Model

The present disclosure also contemplates collecting a training data set for training the BS-beam handover joint prediction model. An input in the training data set may be the link condition information related to the UE over a period of time, and an output may be the event type of the UE's RLF or handover-related event, the event occurrence time, and the target handover base station-beam, wherein the training data set is obtained through a traditional base station handover or RRC re-establishment process after an RLF occurs.

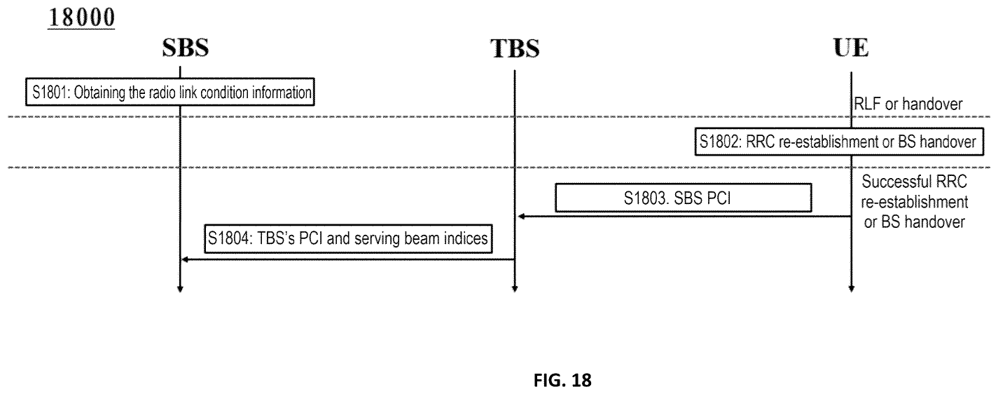

FIG. 18 is a flow diagram illustrating an exemplary method 18000 of collecting training data according to an embodiment of the present disclosure. As shown in FIG. 18, the method 18000 may comprise the following operations:

S1801, at which the SBS obtains the radio link condition information.

S1802, at which, when the RLF or handover occurs, the UE accesses a new base station by using a traditional RRC re-establishment or base station handover process.

S1803, at which the UE notifies a newly accessed target BS (TBS) of a PCI of a previous serving BS (SBS).

S1804, at which the TBS notifies the SBS of TBS's own PCI and serving beam through an Xn interface.

In order to better serve optimization of the AI model, in the AI model training data collection phase, in addition to the index and serving beam of the TBS, the TBS may further feedback service quality information (e.g., RSRP of the serving beam) for optimizing the AI prediction model, to the SBS.

As described above, in the model training data collection phase, the prediction input is obtained by the SBS, and the TBS and serving beam labels for the UE access that are obtained through the traditional RRC re-establishment or BS handover process, as well as the event occurrence time, are fed back to the SBS, so that the model can learn mapping between the prediction input and the output. It should be noted that, when the prediction model is deployed at the SBS, after the UE accesses the TBS by using the traditional RRC re-establishment process, the TBS cannot know the PCI of the SBS, and therefore cannot notify the SBS of the TBS-related information for the model training. Therefore, the UE feeds back the PCI of the SBS to the TBS, so that the TBS can notify the SBS of its own PCI and serving beam.

In step S1804, the TBS may also notify the SBS of the occurrence time of the RLF and handover through the Xn interface.

It can be appreciated that for the BS handover, the handovered-to base station knows a time when the UE performs the BS handover, so that in the data transmission from the handovered-to base station to the serving base station through the Xn interface, the handover time can be included as the training data for output. For the RLF, the handovered-to base station does not know the true time when the RLF occurs at the UE, since a possible waiting time for RRC re-establishment is very long, and the time of the RRC re-establishment is not equal to the time of the RLF, so that for the RLF occurrence time, the UE may report the occurrence time of the RLF to the handovered-to base station, and then the handovered-to base station notifies the serving base station deployed with the AI prediction model through the Xn interface.

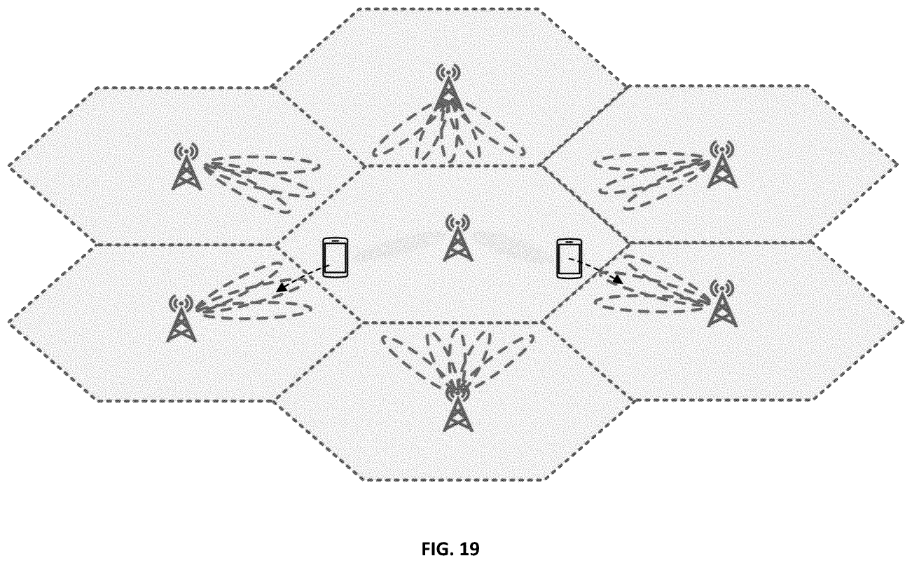

As described above, the BS-beam handover joint prediction depends on accurate modeling of the surrounding radio environment, but the traditional method has difficulty in adaptively modeling a high-dimensional radio environment feature, and therefore it is considered that the prediction is implemented by using deep learning. Further, there may be more neighboring BSs around the SBS, so that selecting a target beam, e.g., an optimal beam, from all candidate beams of these neighboring BSs will result in a larger prediction output space. However, when the UE moves to an edge area of the SBS cell and an RLF may be triggered, only beams of a small number of neighboring BSs may be the target beam, as shown in FIG. 19. Therefore, to reduce the prediction output space, for the prediction output of deep learning, only BS-beam sets with highest occurrence frequencies and a total proportion greater than a preset threshold (e.g., 99% or 99.9%) in the training data set may be considered.

The BS-beam handover joint prediction model may employ a deep learning model. In some embodiments, a prediction output of the BS-beam handover joint prediction model may include only base station-beam sets with highest occurrence frequencies and a total proportion greater than a preset threshold in the training data set. For example, assume that in the training data collection phase, labels in total obtained by the serving BS include N neighboring BSs (assuming that there are M candidate beams for each neighboring BS, there are MN candidate beams in total), and J beams in total, where J is less than MN. The reason why the number J of the beams in the labels is less than or equal to the total number MN of the candidate beams is that only a beam neighboring the serving BS may become the handovered-to beam (as shown in FIG. 19). Further, the occurrence frequencies of the J beams in the labels are ranked in descending order, and only K beams with highest frequencies are selected as prediction output labels. The preference criterion for K is that a proportion of total frequencies of the K beams in all the labels is greater than a preset threshold, for example, 99% or 99.9%, so that the prediction output space is further reduced to reduce the output load of the AI model in the case where training samples are hardly reduced.

More specifically, a specific [PCI-beam]pairing may represent one possible output, e.g., [cell 7-beam 2], [cell 9-beam 2], and [cell 7-beam 6] represent three different possible outputs. In the training phase, a large amount of training data may be collected, each training data comprising a specific [PCI-beam]pairing. For one serving base station, only a small number of beams in all neighboring base stations around may become handovered-to beams for the current serving base station, so that the [PCI-beam]pairings can be used as different outputs of training samples. As an example, if we consider that in all the training data, there are 6 PCI-beam pairings in total, namely [cell 7-beam 2], [cell 7-beam 4], and [cell 7-beam 6], [cell 9-beam 1], [cell 9-beam 2], and [cell 3-beam 5], each having a proportion of 30%, 20%, 20%, 20%, 9.9%, 0.1%, a proportion threshold being set to 99%, we first search for a set of pairings for which the sum of the proportions is greater than the threshold in descending order of the proportions, and find that the top 5 pairings can already reach 99%, then exclude the remaining PCI-beam pairing with the probability of 0.1%, so that radio link condition information corresponding to the PCI-beam pairing with the probability of 0.1% is not incorporated into the input, and the output is a 5×1 vector, each element representing the probability of the determination on a handover to the corresponding PCI-beam pairing.

As described above, the BS-beam handover joint prediction model may include one or more AI sub-models deployed on the serving base station and/or UE. For the case where the BS-beam handover joint prediction model 500, for example as shown in FIG. 5, includes one AI sub-model 501 deployed on the serving base station, a training data set of the AI model may include: an input being radio link information of the UE with the serving base station and/or the neighboring base station over a period of time, and an output being a type and time of an event which occurs on the UE, as well as an optimal handover BS and beam.

For the case where the BS-beam handover joint prediction model 700, for example as shown in FIG. 7, includes two AI sub-models deployed on the serving base station, two training data sets may be used. The training data set for the second AI sub-model 701 may include: an input which may be radio link information of the UE with the serving base station and/or the neighboring base station over a period of time, and an output which may be a type and time of an event which occurs on the UE, for training the RLF or handover predetermination model. The training data set for the third AI sub-model 702 may include: an input which may be radio link information of the UE with the serving base station and/or the neighboring base station over a period of time and the possibly additional measurement (e.g., the BFR measurement result obtained after the A3 event is triggered), and an output which may be an optimal handover BS and beam for training the BS/beam prediction model.

Those skilled in the art can establish different training data sets as needed to train the various AI sub-models included in the BS-beam handover joint prediction model of the present disclosure.

### Enabling of AI-Assisted Service and Activation and Deactivation of BS-Beam Handover Joint Prediction Model for UE

The present disclosure may be used for a UE with lower tolerance latency (e.g., an ultra-reliable low latency transmission uRLLC scenario). The present disclosure contemplates a condition for providing a AI-assisted service, which may be characterized in that: the UE feeds back its own tolerance latency to the serving BS, and the serving BS decides whether to provide/activate/enable the AI-assisted service according to the tolerance latency. The AI-assisted service may include the BS-beam handover joint prediction and other services according to the embodiment of the present disclosure.

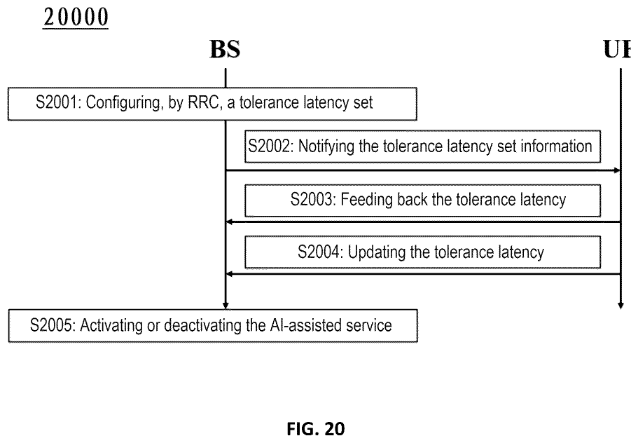

FIG. 20 is a flow diagram illustrating a method 20000 of activating an AI-assisted RLF/handover prediction service according to an embodiment of the present disclosure. As shown in FIG. 20, the method 20000 may comprise an operation S2001, at which for a BS configured with an AI-assisted service, a tolerance latency set is configured by RRC for feeding back tolerance latency by the user.

The method 20000 may further comprise an operation S2002, at which after the UE accesses the BS, the serving BS notifies the UE of the tolerance latency set information through an RRC Reconfiguration message.

The method 20000 may further comprise an operation S2003, at which the UE feeds back its own tolerance latency to the BS.

The method 20000 may further comprise an operation S2004, at which when the tolerance latency changes, the UE notifies the BS of the changed tolerance latency.

The method 20000 may further comprise an operation S2005, at which the BS activates or deactivates the AI-assisted RLF/handover prediction service based on the tolerance latency fed back or updated by the UE.

In some embodiments, when the tolerance latency of the UE is less than a preset threshold of the BS, the BS may activate the AI-assisted service. When the tolerance latency of the UE is greater than the preset threshold of the BS, the BS may deactivate the AI-assisted service.

For the case where the BS serves a plurality of UEs, if the tolerance latency at least one UE itself feeds back is less than the preset threshold of the BS, the AI-assisted service may be enabled on the BS (i.e., the AI function is enabled). For UEs whose own tolerance latency meets the requirements, the BS-beam handover joint prediction model according to the embodiment of the present disclosure and possibly other supported AI models, for example, may be activated/applied for each of these UEs according to a specific situation.

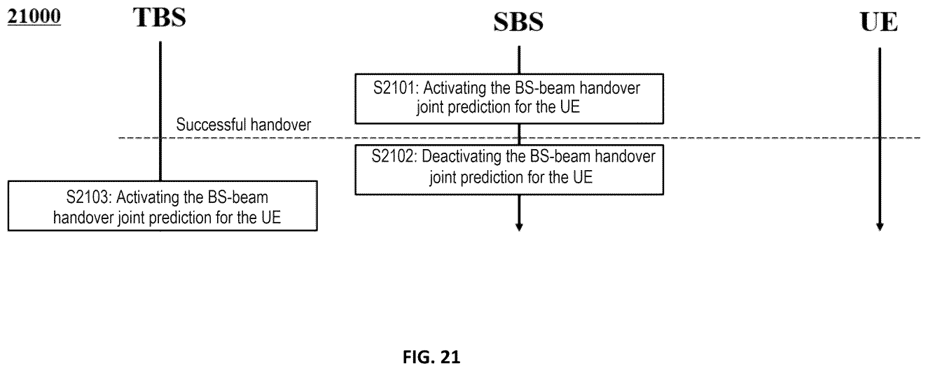

FIG. 21 is a flow diagram illustrating a method 21000 of activating and deactivating a BS-beam handover joint prediction model for a UE according to an embodiment of the present disclosure.

As shown in FIG. 21, the method 21000 comprises the following operations:

operation S2101, at which for example, when the communication quality of one UE is below a threshold, the SBS activates the BS-beam handover joint prediction model for the UE. Activating the BS-beam handover joint prediction model for the UE may also be based on, for example, the predetermination that the A3 event is imminent, etc.

Operation S2102, at which after the handover is completed, the SBS deactivates the BS-beam handover joint prediction model for the UE. After the handover is completed, the SBS may simultaneously deactivate other AI models for the UE, including but not limited to one or more AI models for CSI feedback, intra-TBS beam management, radio positioning, etc.

operation S2103, at which when the UE completes the handover and accesses the TBS, the TBS activates the BS-beam handover joint prediction model for the UE when the communication quality of the UE is below a threshold. When the UE completes the handover and accesses the TBS, the TBS may activate other AI models for the UE, including but not limited to one or more AI models for CSI feedback, intra-TBS beam management, radio positioning, etc.

### Update and Optimization of BS-Beam Handover Joint Prediction Model

In a real scenario, radio environments change continuously, and the model prediction performance tends to decrease gradually over time. The present disclosure contemplates triggering model update when necessary to ensure prediction accuracy.

In some embodiments, online update for the BS-beam handover joint prediction model is provided. When a prediction accuracy index (including but not limited to a success rate of a BS handover under preset overhead) does not meet a preset threshold, online update of the model is activated, i.e., training data is collected to update the model by using, for example, the process described in FIG. 18. The above preset threshold includes, but is not limited to, a fixed threshold, a relative threshold compared to prediction accuracy when the model was initially deployed.

For example, the success rate of the BS handover may be given by the S1706 of the BS-beam handover process shown in FIG. 17. When the UE decides to access the PBS, it is regarded as a handover success; and when the UE decides not to access the PBS under a preset handover overhead (e.g., measuring no more than 8 beams or attempting to access no more than 2 PBSs), it is regarded as a handover failure.

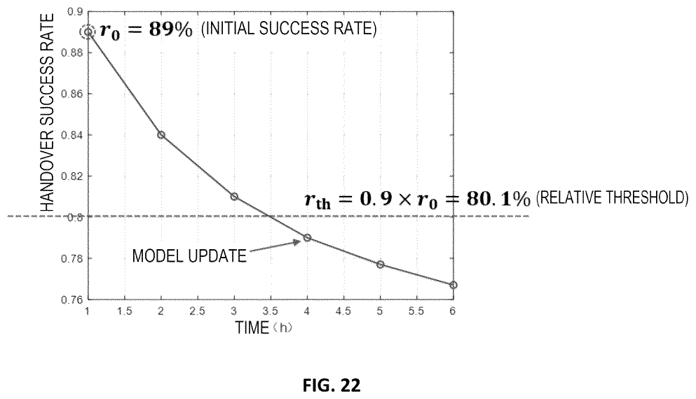

FIG. 22 illustrates an example of triggering model update based on a relative threshold according to an embodiment of the present disclosure. When a prediction model starts to be deployed, it is considered that the prediction model is capable of matching the current environment, and at this time, an initial handover success rate r₀=89%, which represents an upper limit of the capability of the model in the current radio environment. As the radio environment fluctuates, the prediction accuracy of the model gradually decreases. A relative threshold is set to rₜₕ=0.9×r₀=80.1%, so that when it is monitored within a certain period of time that the handover success rate is less than the threshold, the model update is triggered.

The traditional fixed threshold is difficult to adapt to the prediction precision difference of the model itself in different environments. Compared with the fixed threshold, this relative threshold-based mechanism which takes the prediction precision of the model at the initial deployment time (influenced minimally by environmental changes) as a reference can better adapt to different radio environments.

After the user hands over to the TBS, when a handover or RLF occurs again within a preset time threshold, the TBS may notify the SBS of this event via the Xn interface. The time threshold is typically short to evaluate whether a ping-pong effect or a non-optimal handover is generated. The failure feedback can be used for optimizing RLF/handover event predetermination of the AI model, PBS prediction, and access strategy (which can be adjusted by, for example, enhancement learning, based on the above feedback), to reduce the influence such as the ping-pong effect.

### Simulation

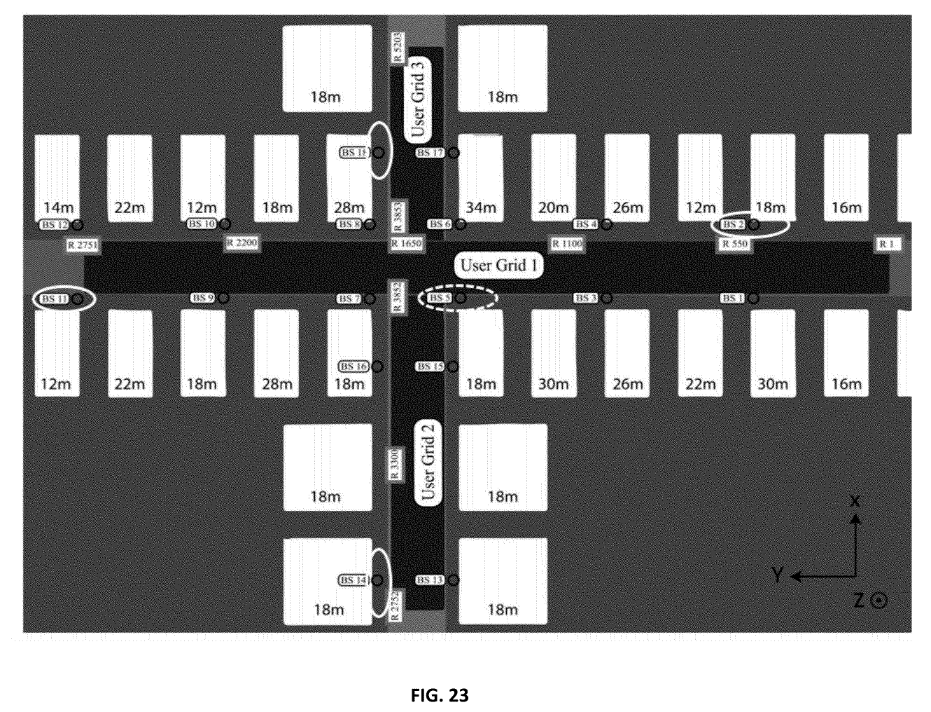

Considering a radio channel environment as shown in FIG. 23 (see A. Alkhateeb, “DeepMIMO: A genetic deep learning dataset for millimeter wave and massive MIMO applications,” in Proc. ITA Workshop, San Diego, CA, USA, February 2019, pp. 1-8), CSI is calculated according to attenuation, latency, angle of arrival (AoA), angle of departure (AoD), and other features of each path by using a Saleh-Valenzuela channel model. An SBS index of the UE is 5 (shown as a white dotted circle), indices of neighboring 4 BSs are 2, 11, 14, 18 (shown as white solid circles), the number of candidate beams of each BS is 32, and the neighboring BSs contain 128 candidate beams in total. Other simulation parameters are shown in Table 1.

TABLE 1
channel simulation parameters

| Parameter | Value | |
|---|---|---|
| SBS index | 5 | |
| neighboring BS index | 2, 11, 14, 18 | |
| center frequency | 28 | GHz |
| number of BS antennas | 32 (ULA) | |
| number of UE antennas | 1 | |
| number of BS candidate beams | 32 | |
| bandwidth | 50 | MHz |
| noise factor | 5 | dB |

For the BS-beam handover joint prediction model, it is implemented by using a convolutional neural network (CNN), whose specific structure and parameters are shown in Table 2, wherein fᵢ and fₒ represent the numbers of input and output feature channels respectively, (a,b,c) represent a convolutional kernel size, a down-sampling step size, and a boarder padding size of a convolutional layer, respectively, BatchNorm refers to batch normalization, AvgPooling refers to average value pooling, ReLU refers to a ReLU activation function, dropout refers to a random dropout strategy for suppressing overfitting, and Nₒᵤₜ refers to an output size. In the training dataset, in the 128 candidate beams of all the neighboring BSs, handover may be made to only 62 beams therein, so that in order to effectively reduce the prediction output space, in the simulation, Nₒᵤₜ=62.

TABLE 2
Prediction model structure and parameter

| Structure | Parameter |
|---|---|
| Convolutional | fᵢ = 1, fₒ = 64, (3, 1, 1), BatchNorm, AvgPooling, |
| layer | ReLU |
| Convolutional | fᵢ = 64, fₒ = 128, (3, 1, 1), BatchNorm, AvgPooling, |
| layer | ReLU |
| Convolutional | fᵢ = 128, fₒ = 256, (3, 1, 1), BatchNorm, AvgPooling, |
| layer | ReLU |
| Convolutional | fᵢ = 256, fₒ = 256, (3, 1, 1), BatchNorm, AvgPooling, |
| layer | ReLU |
| Convolutional | fᵢ = 256, fₒ = 256, (3, 1, 1), BatchNorm, AvgPooling, |
| layer | ReLU, dropout |
| Fully connected | fᵢ = 256, fₒ = Nₒᵤₜ |
| layer | |

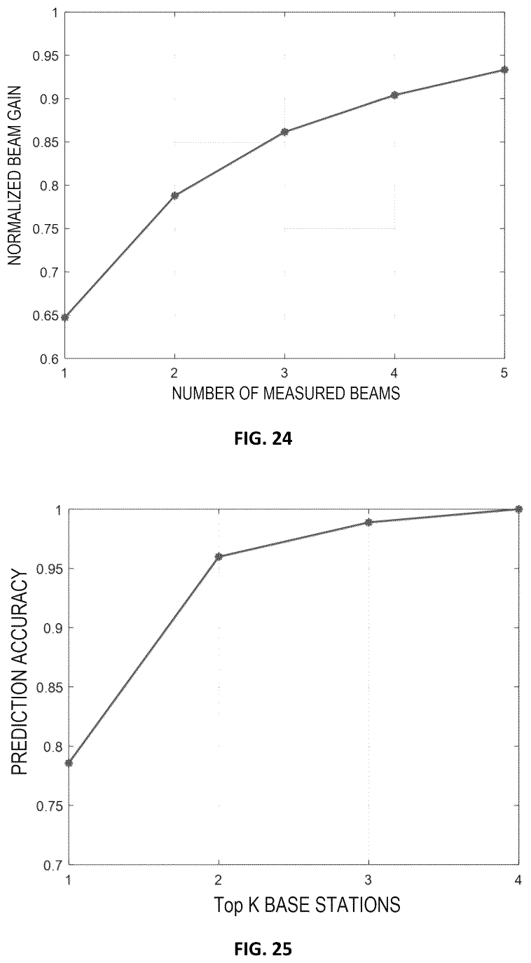

FIG. 24 illustrates normalized beam gain performance of BS-beam handover joint prediction according to an embodiment of the present disclosure, the performance being calculated as a gain ratio between a predicted optimal beam and an actual optimal beam. In the figure, it is further considered that a certain number of beams (as abscissa) with highest prediction probabilities are measured, and a beam with highest receiving power is selected as the predicted optimal beam and its normalized beam gain is evaluated. It can be seen that the predicted optimal beam on average can reach a normalized beam gain of 64%; when it is further considered that 5 beams with highest probabilities are measured, the provided model can achieve a normalized beam gain of 93%, i.e. almost perfect beam alignment.

FIG. 25 illustrates a variation curve of accuracy of BS prediction with the number of base stations according to an embodiment of the present disclosure, the accuracy being calculated as a proportion of the predicted optimal BS being an actual optimal BS (target beam) which is defined as a TBS corresponding to the optimal BS-beam handover. Since the prediction result is the beam probability, summation of the beam probabilities of each BS is taken as the BS probability. Similar to FIG. 24, in the figure, it is further considered that a certain number of BSs with highest prediction probabilities are measured as abscissa. It can be seen that the prediction accuracy of the optimal BS is 78.6%, and there is a probability of 96% that the optimal BS can be found when two BSs are searched for.

Finally, for the RLF event, we evaluate the latency contrast between the traditional RRC re-establishment solution and the proposed solution. Assuming that a SSB broadcast period of the neighboring BS is τ_{SSB}=80 ms, the RLF may be triggered at any time. For the traditional RRC re-establishment process, an average latency for monitoring the TBS broadcasting the SSB is τ_{SSB}/2=40 ms, and 32 candidate beams need to be measured simultaneously to find the optimal beam. However, for the proposed solution, as shown in FIG. 24, almost perfect beam alignment can be achieved when only 5 beams are measured. Therefore, the proposed solution can significantly reduce the latency of the BS handover.

### Serving Base Station

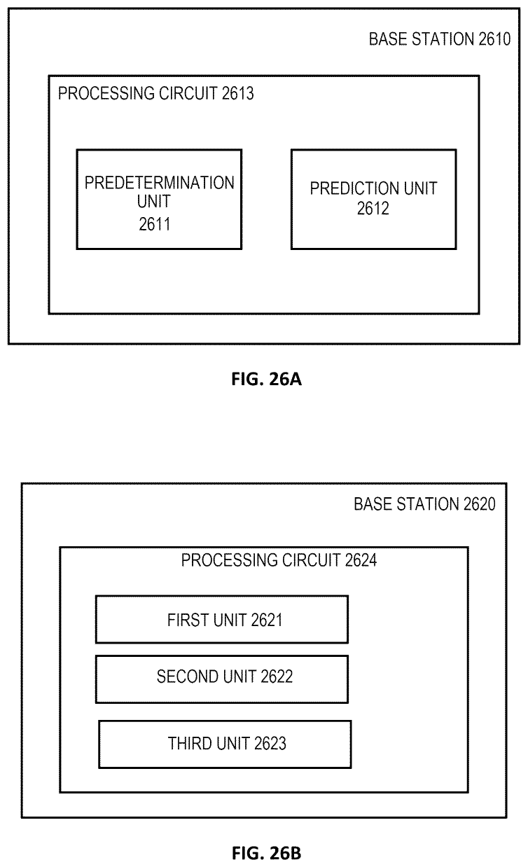

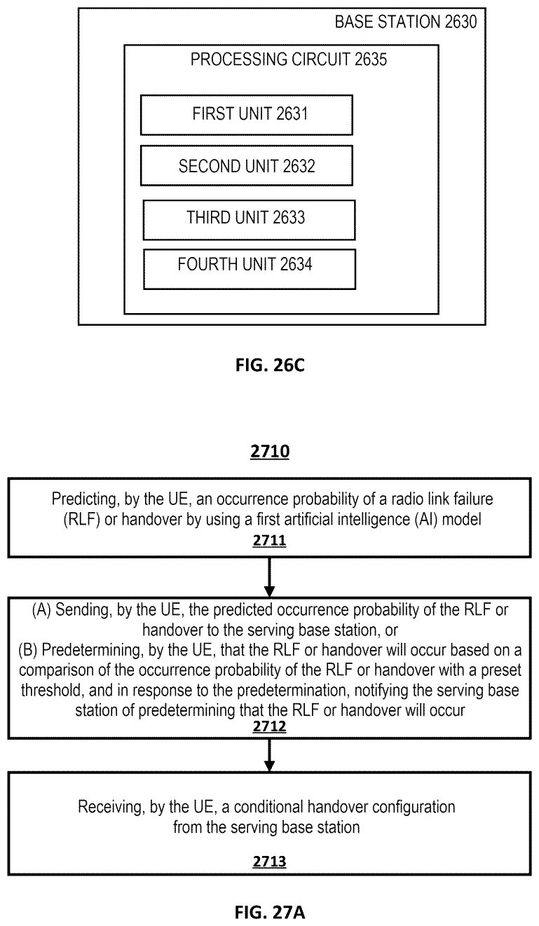

FIG. 26A illustrates a block diagram of an exemplary configuration of a base station 2610 according to some embodiments of the present disclosure. The base station 2610 may implement the serving base station according to the embodiments of the present disclosure.

As shown, the base station 2610 may comprise a processing circuit 2613. The processing circuit 2613 may comprise a predetermination unit 2611. The predetermination unit 2611 is configured to perform an operation related to predetermination of an RLF or handover. In some embodiments, the predetermination unit may be configured to predetermine that a radio link failure (RLF) or handover will occur based at least on radio link condition information related to a user equipment (UE), as illustrated in the operation 3101 of FIG. 3A. In some embodiments, the predetermination unit may be configured to predetermine that a radio link failure (RLF) or handover will occur by using an AI model based at least on radio link condition information related to a user equipment (UE), as illustrated in the operation 3201 of FIG. 3B or the operation 3401 of FIG. 3D.

As shown in the figure, the processing circuit 2613 may also comprise a prediction unit 2612. The prediction unit 2612 is configured to perform an operation related to prediction of a target BS-beam set. In some embodiments, the prediction unit 2612 may be configured to predict a target base station and a beam used by the target base station to serve the user equipment (UE) by using the AI model based at least on the radio link condition information related to the UE, as illustrated in the operation 3301 of FIG. 3C or as illustrated in the operation 3402 of FIG. 3D.

Those skilled in the art can appreciate that the processing circuit 2613 may include more or fewer units than those shown in FIG. 26A.

For example, in some embodiments, the processing circuit 2613 may not include the predetermination unit 2611, but the UE performs the operation related to the predetermination of the RLF or handover. In some embodiments, the base station 2610 may not include the predetermination unit 2612, and after making the predetermination of the RLF or handover, the base station 2610 may perform configuration for performing a conditional handover or assisting beam recovery according to a conventional method.

FIG. 26B illustrates a block diagram of an exemplary configuration of a base station 2620 according to some embodiments of the present disclosure. The base station 2620 may implement the serving base station according to the embodiments of the present disclosure.

As shown in FIG. 26B, the base station 2620 may comprise a processing circuit 2624. The processing circuit 2624 may comprise a first unit 2621, which is configured to predict an occurrence probability of the RLF or handover and a target base station-beam set by using a first AI sub-model based at least on the radio link condition information related to the UE.

As shown in FIG. 26B, the processing circuit 2624 may further comprise a second unit 2622, which is configured to predetermine that the RLF or handover will occur based on a comparison of the occurrence probability of the RLF or handover with a preset threshold.

As shown in FIG. 26B, the processing circuit 2624 may further comprise a third unit 2623, which is configured to, in response to the predetermination, use the target base station-beam set for configuring a conditional handover.

FIG. 26C illustrates a block diagram of an exemplary configuration of a base station 2630 according to some embodiments of the present disclosure. The base station 2630 may implement the serving base station according to the embodiments of the present disclosure.

As shown in FIG. 26C, the base station 2630 may comprise a processing circuit 2635. The processing circuit 2635 may comprise a first unit 2631, which is configured to predict an occurrence probability of the RLF or handover using a second AI sub-model based on the radio link condition information related to the UE.

As shown in FIG. 26C, the processing circuit 2635 may further comprise a second unit 2632, which is configured to predetermine that the RLF or handover will occur based on a comparison of the occurrence probability of the RLF or handover with a preset threshold.

As shown in FIG. 26C, the processing circuit 2635 may further comprise a third unit 2633, which is configured to, in response to the predetermination, collect, by the serving base station, supplementary radio link condition information related to the UE.

As shown in FIG. 26C, the processing circuit 2635 may further comprise a fourth unit 2634, which is configured to, in response to the predetermination, predict a target base station-beam set for configuring a conditional handover by using a third AI sub-model based on the radio link condition information related to the UE and the supplementary radio link condition information related to the UE.

It can be understood by those skilled in the art that FIGS. 26A-26C illustrate only some exemplary unit configurations of the base station, and those skilled in the art can implement various corresponding units according to operations to be performed by the base station. More specifically, in general, the base station includes a processor (processing circuit) and a memory (not shown), the memory storing computer-readable instructions which contain corresponding instructions for the various operations to be performed by the base station. For example, for a serving base station according to an embodiment of the present disclosure, the computer-readable instructions may include, but are not limited to, instructions for performing, for example, the operation 3101 in FIG. 3A, the operation 3201 in FIG. 3B, the operation 3301 in FIG. 3C, the operations 3401 and 3402 in FIG. 3D, the operations 601-603 in FIG. 6, the operations 801-804 in FIG. 8, and the operations performed by the SBS in FIGS. 11-13, 16-18, 20-21, etc., and the processor may, by reading and executing the corresponding instructions for the various operations to be performed by the base station that are stored in the memory, implement the functions of the units corresponding to these operations.

### User Equipment

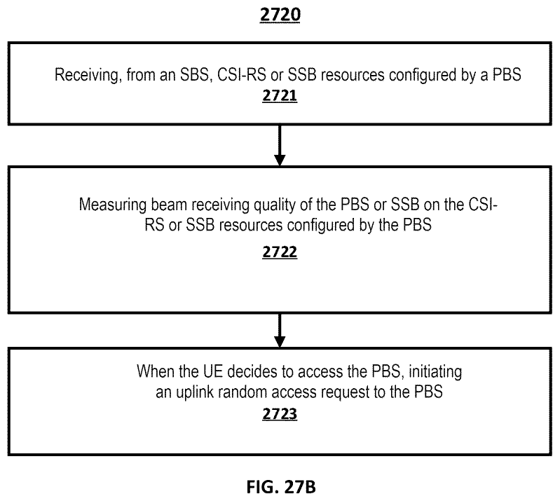

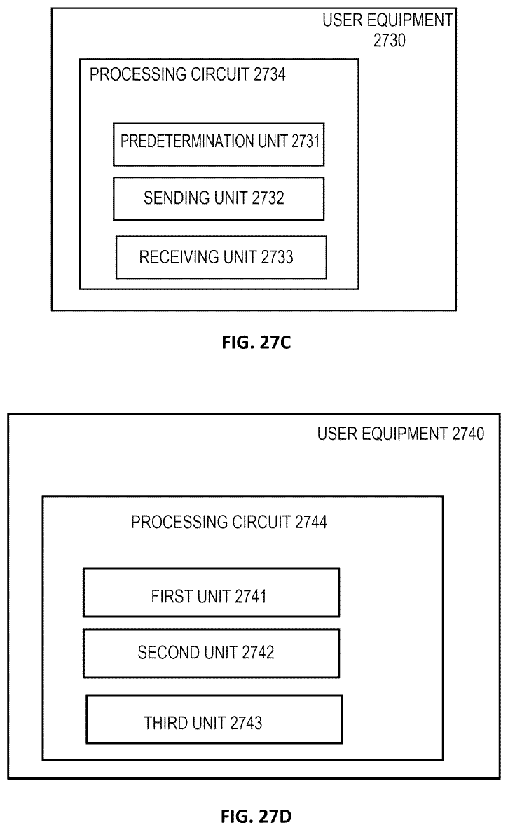

FIG. 27A illustrates a flow diagram of an exemplary method 2710 for radio communication according to an embodiment of the present disclosure. The method may be performed by a user equipment according to an embodiment of the present disclosure.

As shown in FIG. 27A, the method 2710 may comprise an operation 2711, at which the UE predicts an occurrence probability of a radio link failure (RLF) or handover by using a first artificial intelligence (AI) model, the prediction being based at least on radio link condition information related to the user equipment (UE), the radio link condition information comprising at least information reflecting condition of a radio link between the UE and a serving base station. The first AI model may be similar to the fifth AI sub-model described previously.

As shown in FIG. 27A, the method 2710 may comprise an operation 2712, at which (A) the UE sends the predicted occurrence probability of the RLF or handover to the serving base station, or (B) the UE predetermines that the RLF or handover will occur based on a comparison of the occurrence probability of the RLF or handover with a preset threshold, and in response to the predetermination, notifies the serving base station of predetermining that the RLF or handover will occur.

As shown in FIG. 27A, the method 2710 may comprise an operation 2713, at which the UE receives, from the serving base station, a conditional handover configuration, which is based on a target base station and a beam used by the target base station to serve the user equipment, which are predicted by the serving base station by using a second AI model in response to the notification of the predetermination received from the UE, wherein, the prediction of the serving base station is based at least on the radio link condition information related to the UE. The second AI model is similar to the sixth AI sub-model described previously.

FIG. 27B illustrates a flow diagram of an exemplary method 2720 for radio communication according to an embodiment of the present disclosure. The method may be performed by the user equipment according to the embodiments of the present disclosure.

As shown in FIG. 27B, the method 2720 may comprise an operation 2721, at which the UE receives, from an SBS, CSI-RS or SSB resources configured by a PBS.

The method 2720 may also comprise an operation 2722, at which the UE measures beam receiving quality of the PBS or SSB on the CSI-RS or SSB resources configured by the PBS.

The method 2720 may also comprise an operation 2723, at which when the UE decides to access the PBS, the UE initiates an uplink random access request to the PBS.

FIG. 27C illustrates a block diagram of an exemplary configuration of a user equipment 2730 according to an embodiment of the present disclosure.

As shown in FIG. 27C, the user equipment 2730 may comprise a processing circuit 2734. The processing circuit 2734 may comprise a predetermination unit 2731. The predetermination unit 2731 is configured to perform an operation related to predetermination of an RLF or handover. In some embodiments, the predetermination unit may be configured to predetermine that the radio link failure (RLF) or handover will occur based at least on radio link condition information related to the user equipment (UE), as illustrated in the operation 3101 of FIG. 3A. In some embodiments, the predetermination unit may be configured to predetermine that the radio link failure (RLF) or handover will occur, using an AI model, based at least on radio link condition information related to the user equipment (UE), as illustrated in the operation 3201 of FIG. 3B.

In some embodiments, the predetermination unit 2731 may be configured to predict an occurrence probability of the radio link failure (RLF) or handover. In other embodiments, the predetermination unit 2731 may be configured to predict an occurrence probability of the radio link failure (RLF) or handover, and predetermine that the RLF or handover will occur based on a comparison of the occurrence probability of the RLF or handover with a preset threshold.

As shown in FIG. 27C, the processing circuit 2734 may further comprise a sending unit 2732. The sending unit 2732 may be configured to send the occurrence probability of the RLF or handover that is predicted by the predetermination unit 2731 to a serving base station, or configured to send the predetermination result of the predetermination unit 2731 to a serving base station.

As shown in FIG. 27C, the processing circuit 2734 may further comprise a receiving unit 2733. The receiving unit 2733 may be configured to receive, from the serving base station, a conditional handover configuration, which is based on a target base station and a beam used by the target base station to serve the user equipment, which are predicted by the serving base station by using a second AI model in response to the notification of the predetermination received from the UE, wherein, the prediction of the serving base station is based at least on the radio link condition information related to the UE.

FIG. 27D illustrates a block diagram of an exemplary configuration of a user equipment 2740 according to an embodiment of the present disclosure.

As shown in FIG. 27D, the user equipment 2740 may comprise a processing circuit 2744. The processing circuit 2744 may comprise a first unit 2741, which is configured to receive, from SBS, CSI-RS or SSB resources configured by a PBS.

The processing circuit 2744 may also comprise a second unit 2742, which is configured to measure beam receiving quality of the PBS or SSB on the CSI-RS or SSB resources configured by the PBS.

The processing circuit 2744 may further comprise a third unit 2743, which is configured to, when the UE decides to access the PBS, initiate an uplink random access request to the PBS.

It can be understood by those skilled in the art that FIGS. 27A-27D only illustrate some exemplary operations and unit configurations of the user equipment, and those skilled in the art can implement various corresponding units according to operations to be performed by the user equipment. More specifically, in general, the user equipment includes a processor (processing circuit) and a memory (not shown), the memory storing computer-readable instructions which contain corresponding instructions for the various operations to be performed by the user equipment. For example, for a user equipment according to an embodiment of the present disclosure, the computer-readable instructions may include, but are not limited to, instructions for performing, for example, the operation 3101 in FIG. 3A, the operation 3201 in FIG. 3B, the operation 3301 in FIG. 3C, the operation 3401 in FIG. 3D, the operations performed by the UE in FIGS. 11-13, 16-18, 20-21, and 27A-27B, etc., and the processor may, by reading and executing the corresponding instructions stored in the memory for the various operations to be performed by the UE, implement the functions of the units corresponding to these operations.

It can be understood by those skilled in the art that the structures and deployments of the first to seventh AI sub-models mentioned in the present disclosure are schematically illustrated for illustrative purposes and do not represent limitations of the present disclosure, and those skilled in the art can design and deploy different numbers of AI models with different structures to implement the base station-beam handover joint prediction model as needed. The expressions “first” to “seventh” are only for clarity of distinction and do not denote any order or association.

Next, an electronic device and communication method according to some embodiments of the present disclosure will be described.

### Exemplary Implementations of the Present Disclosure

According to the embodiments of the present disclosure, various implementations for implementing the concepts of the present disclosure can be contemplated, including but not limited to:

1. A method for radio communication, comprising:
predetermining that a radio link failure (RLF) or handover will occur by using an artificial intelligence (AI) model, wherein, the predetermination is based at least on radio link condition information related to a user equipment (UE), and the radio link condition information comprises at least information reflecting condition of a radio link between the UE and a serving base station (SBS).

2. The method according to article 1, further comprising:
in response to the predetermination, predicting a target base station and a beam used by the target base station to serve the user equipment for configuring a conditional handover, by using the AI model, wherein, the prediction is based at least on the radio link condition information related to the UE.

3. The method according to article 2, wherein an output of the AI model comprises a target base station-beam set, the target base station-beam set comprising one or more target base station-beam pairings, each pairing indicating one target base station and one beam used by the target base station to serve the user equipment that are predicted.

4. The method according to article 1, wherein the radio link condition information further comprises information reflecting condition of a radio link between the UE and one or more neighboring base stations.

5. The method according to article 3, wherein the radio link condition information comprises at least one of:
a beam measurement result;
a channel state information (CSI) measurement result;
a mobility measurement result;
real-time geographic environment and radio environment information comprising at least one of a high-precision map or an electromagnetic map;
a location and motion feature of the UE; or
data of sensors comprising at least one of an accelerometer or barometer of the UE.

6. The method according to article 5, wherein the AI model comprises one or more AI sub-models, an input of each AI sub-model in the AI model comprising at least the radio link condition information related to the UE.

7. The method according to article 6, wherein the AI model comprises a first AI sub-model deployed at the serving base station, the method further comprising:
predicting, by the serving base station, an occurrence probability of the RLF or handover and a target base station-beam set by using the first AI sub-model, based at least on the radio link condition information related to the UE;
predetermining, by the serving base station, that the RLF or handover will occur based on a comparison of the occurrence probability of the RLF or handover with a preset threshold; and
in response to the predetermination, using, by the serving base station, the target base station-beam set for configuring the conditional handover.

8. The method according to article 6, wherein the AI model comprises a second AI sub-model and a third AI sub-model deployed at the serving base station, the method further comprising:
predicting, by the serving base station, an occurrence probability of the RLF or handover by using the second AI sub-model, based on the radio link condition information related to the UE;
predetermining, by the serving base station, that the RLF or handover will occur based on a comparison of the occurrence probability of the RLF or handover with a preset threshold; and
in response to the predetermination, predicting, by the serving base station, a target base station-beam set for configuring the conditional handover by using the third AI sub-model, based on the radio link condition information related to the UE and supplementary radio link condition information related to the UE.

9. The method according to article 7 or 8, wherein the AI model further comprises a fourth AI sub-model deployed at the UE, the method further comprising:
predicting, by the UE, the occurrence probability of the RLF or handover by using the fourth AI sub-model, based at least on the radio link condition information related to the UE; and
sending, by the UE, the predicted occurrence probability of the RLF or handover to the serving base station,
wherein, the occurrence probability of the RLF or handover of the UE is comprised in the radio link condition information related to the UE.

10. The method according to article 6, wherein the AI model comprises a fifth AI sub-model deployed at the UE and a sixth AI sub-model deployed at the serving base station, the method further comprising:
predicting, by the UE, an occurrence probability of the RLF or handover by using the fifth AI sub-model, based at least on the radio link condition information related to the UE;
sending, by the UE, the predicted occurrence probability of the RLF or handover to the serving base station;
predetermining, by the serving base station, that the RLF or handover will occur based on a comparison of the predicted occurrence probability of the RLF or handover that is received from the UE with a preset threshold; and
in response to the predetermination, predicting, by the serving base station, a target base station-beam set for configuring the conditional handover by using the sixth AI sub-model, based at least on the radio link condition information related to the UE.

11. The method according to article 5, wherein beam measurement is triggered based on at least one of being below a preset communication quality threshold or response to the predetermination that the RLF or handover will occur,
wherein, the beam measurement is based on at least one of:
(1) adjacent beam measurement, in which a beam adjacent to a current serving beam in angle is measured; or
(2) beam measurement based on probability priorities, in which a number of beams with each beam being selected based on a predicted probability that the beam becomes an optimal beam are measured.

12. The method according to article 5, further comprising:
configuring, by the serving base station, channel state information reference signal (CSI-RS) resources for downlink beam failure recovery (BFR) measurement;
sending, by the serving base station, a CSI-RS for performing the downlink BFR measurement by the UE;
sending, by the UE, a downlink BFR measurement result to the service base station; and
sending, by the UE, a UE receiving beam pattern to the serving base station,
wherein, the beam measurement result comprises the downlink BFR measurement result and the UE receiving beam pattern.

13. The method according to article 5, further comprising:
configuring, by the serving base station, sounding reference signal (SRS) resources for uplink BFR measurement;
notifying, by the serving base station, the configured SRS resources to the UE;
sending, by the UE, an SRS;
performing, by the serving base station, the uplink BFR measurement to obtain a uplink BFR measurement result; and
feeding back, by the UE, a UE transmitting beam pattern to the serving base station,
wherein, the beam measurement result comprises the uplink BFR measurement result and the UE transmitting beam pattern.

14. The method according to article 12 or 13, further comprising: feeding back, by the UE, absolute angle information of a beam at the UE side.

15. The method according to article 14, further comprising:
configuring, by the serving base station, a granularity of absolute beam angle feedback for the UE;
notifying, by the serving base station, the granularity of the absolute beam angle feedback to the UE; and
feeding back, by the UE, an absolute beam angle to the serving base station according to the configured granularity.

16. The method according to article 3, further comprising:
selecting, by the serving base station, one or more candidate target base stations based on the predicted target base station-beam set;
sending, by the serving base station, a handover request to a candidate target base station in the one or more candidate target base stations;
if the candidate target base station agrees to handover, performing, by the candidate target base station, access control and radio resource allocation, and feeding back confirmation and related configuration information to the serving base station; and
sending, by the serving base station, a handover configuration to the UE through an RRC reconfiguration message, the handover configuration comprising a handover execution condition of a candidate target cell and configuration information of the candidate target cell that comprises target beam information.

17. The method according to article 16, further comprising:
notifying, by the SBS, a predicted base station (PBS), which is the candidate target base station, of the number of CSI-RS or SSB resources required for UE access, or notifying the PBS of a prediction result of the SBS for deciding, by the PBS itself, the number of configured CSI-RS or SSB resources;
configuring, by the PBS, the CSI-RS or SSB resources for the UE access;
notifying, by the PBS, the SBS of the configured CSI-RS or SSB resources;
notifying, by the SBS, the UE of the CSI-RS or SSB resources configured by the PBS;
measuring, by the UE, beam receiving quality of the PBS or SSB on the CSI-RS or SSB resources configured by the PBS; and
when the UE decides to access the PBS, initiating, by the UE, an uplink random access request to the PBS.

18. The method according to article 17, wherein there are a plurality PBSs, for which a handover attempt is performed in sequence according to predicted priorities, until the handover is successful or a preset upper limit of the number of base stations is reached.

19. The method according to article 17, further comprising: after the user equipment hands over to the PBS, if an RLF or handover-related event occurs again within a preset time threshold, notifying, by the PBS, the SBS of the event through an Xn interface.

20. The method according to article 2, further comprising:
activating, by the serving base station, an AI-assisted service based on tolerance latency information fed back by the UE;
activating, by the serving base station, the AI model for the UE based on communication quality of the UE; and
after the UE hands over from the serving base station to another base station, deactivating the AI model for the UE.

21. The method according to article 1, further comprising: collecting a training data set for training the AI model, wherein an input in the training data set comprises link condition information related to the UE over a period of time, an output comprises an event type of the RLF or handover-related event of the UE and a target handover base station-beam, wherein the training data set is obtained by a traditional base station handover or an RRC re-establishment process after an RLF occurs.

22. The method according to article 21, wherein the AI model employs a deep learning model, and an output of the AI model comprises base station-beam sets with highest occurrence frequencies and a total frequency greater than a preset threshold in the training data set.

23. The method according to article 21, further comprising:
in response to prediction accuracy of the AI model not meeting a preset accuracy threshold, online collecting the training data set for training the AI model to online update the AI model, the preset accuracy threshold comprising a relative threshold compared to prediction accuracy when the AI model was initially deployed.

24. A system for radio communication, comprising:
one or more processors,
a memory storing computer-readable program instructions which, when executed by the one or more processors, cause the method according to any of articles 1-23 to be performed.

25. A non-transitory computer-readable storage medium storing computer-readable program instructions which, when executed by one or more processors, cause the method for radio communication according to any of articles 1-23 to be performed.

26. A method performed by a user equipment (UE), comprising:
predicting an occurrence probability of a radio link failure (RLF) or handover by using a first artificial intelligence (AI) model, the prediction being based at least on radio link condition information related to a user equipment (UE), the radio link condition information comprising at least information reflecting condition of a radio link between the UE and a serving base station.

27. The method according to article 26, further comprising:
sending the predicted occurrence probability of the RLF or handover to the serving base station.

28. The method according to article 27, further comprising:
predetermining that the RLF or handover will occur based on a comparison of the occurrence probability of the RLF or handover with a preset threshold; and
in response to the predetermination, notifying the serving base station of predicting that the RLF or handover will occur.

29. The method according to article 28, further comprising:
receiving, from the serving base station, a conditional handover configuration, which is based on a target base station and a beam used by the target base station to serve the user equipment that are predicted by the serving base station by using a second AI model in response to the notification of the predetermination received from the UE, wherein, the prediction of the serving base station is based at least on the radio link condition information related to the UE.

30. The method according to article 28, wherein the radio link condition information comprises at least one of:
a beam measurement result;
a channel state information (CSI) measurement result;
a mobility measurement result;
real-time geographic environment and radio environment information comprising at least one of a high-precision map or an electromagnetic map;
a location and motion feature of the UE; or
data of sensors comprising at least one of an accelerometer or barometer of the UE.

31. The method according to article 30, wherein beam measurement is triggered based on at least one of being below a preset communication quality threshold and response to the predetermination that the RLF or handover will occur,
Wherein, the beam measurement is based on at least one of:
(1) adjacent beam measurement, in which a beam adjacent to a current serving beam in angle is measured; or
(2) beam measurement based on probability priorities, in which a number of beams with each beam being selected based on a predicted probability that the beam becomes an optimal beam are measured.

32. The method according to article 31, further comprising:
receiving, from the serving base station, CSI-RS resources configured by the serving base station for downlink beam failure recovery (BFR) measurement for performing, by the UE, downlink BFR measurement;
sending a downlink BFR measurement result to the service base station; and
sending a UE receiving beam pattern to the serving base station,
wherein, the beam measurement result comprises the downlink BFR measurement result and the UE receiving beam pattern.

33. The method according to article 31, further comprising:
receiving, from the serving base station, sounding reference signal (SRS) resources configured by the serving base station for uplink BFR measurement;
sending an SRS for performing uplink BFR measurement by the serving base station to obtain an uplink BFR measurement result; and
feeding back a UE transmitting beam pattern to the serving base station,
wherein, the beam measurement result comprises the uplink BFR measurement result and the UE transmitting beam pattern.

34. The method according to article 32 or 33, further comprising:
feeding back absolute angle information of a beam at the UE side.

35. The method according to article 32 or 33, further comprising:
receiving, from the serving base station, a granularity of absolute beam angle feedback configured for the UE; and
feeding back the absolute beam angle to the service base station according to the configured granularity.

36. The method according to article 29, wherein the conditional handover configuration is sent by the serving base station to the UE through an RRC reconfiguration message, the conditional handover configuration containing a handover execution condition of a candidate target cell and configuration information of the candidate target cell that comprises target beam information.

37. The method according to article 36, further comprising:
receiving, from the SBS, CSI-RS or SSB resources configured by a PBS;
measuring beam receiving quality of the PBS or SSB on the CSI-RS or SSB resources configured by the PBS; and
when the UE decides to access the PBS, initiating an uplink random access request to the PBS.

38. A user equipment (UE), comprising
one or more of processors,
a memory storing computer-readable program instructions which, when executed by the one or more processors, cause the method according to any of articles 26-37 to be performed.

39. A non-transitory computer-readable storage medium storing computer-readable program instructions which, when executed by one or more processors, cause the method performed by a user equipment (UE) according to any of articles 26-37 to be performed.

### Application Examples of the Present Disclosure

The techniques described in this disclosure can be applied to a variety of products.

For example, an electronic device according to an embodiment of the present disclosure may be implemented as or installed in various base stations, or implemented as or installed in various user equipments.

A communication method according to an embodiment of the present disclosure may be implemented by the various base stations or user equipments; methods and operations according to an embodiment of the present disclosure may be embodied as computer-executable instructions, which are stored in a non-transitory computer-readable storage medium, and may be executed by the various base stations or user equipments to implement one or more of the functions described above.

The functions of the various elements disclosed herein may be implemented using a circuit or processing circuit, including a general purpose processor, a special purpose processor, an integrated circuit, an AISC (“Application Specific Integrated Circuit”), a traditional circuit, and/or combinations thereof, the circuit or processing circuit being configured or programmed to perform the disclosed functions. The processor is considered as the circuit or processing circuit because the processor includes transistors as well as other circuits. In the present disclosure, a circuit, unit or component is hardware that performs the recited functions or is programmed to perform the recited functions. The hardware may be any hardware disclosed herein or otherwise known that is programmed or configured to perform the recited functions. When the hardware is a processor (which may be considered a circuit), the circuit, unit or component is a combination of hardware and software, the software being used for configuring the hardware and/or the processor.

The techniques according to the embodiments of the present disclosure may be made as various computer program products, which are used in the various base stations or user equipments to implement one or more of the functions described above.

The base station described in this disclosure may be implemented as any type of base station, preferably such as a macro gNB and ng-eNB defined in the 5G NR standard of 3GPP. The gNB may be a gNB covering a cell smaller than a macro cell, such as a pico gNB, a micro gNB, and a homehold (femto) gNB. Alternatively, the base station may be implemented as any other type of base station, such as a NodeB, eNodeB, and base transceiver station (BTS) or network side infrastructure in the next generation communication standard. The base station may further include: one or more remote radio heads (RRHs) configured to control a body of radio communication and arranged in a different location from the body, a radio repeater, an unmanned aerial vehicle tower, a control node in an automated plant, and the like.

The user equipment may be implemented as a mobile terminal (such as a smartphone, a tablet personal computer (PC), a notebook PC, a portable game terminal, a portable/dongle-type mobile router, and a digital camera device), or a car-mounted terminal (such as a car navigation device). The user equipment may also be implemented as a terminal (also referred to as a machine type communication (MTC) terminal) performing machine-to-machine (M2M) communication, an unmanned aerial vehicle, a sensor and actuator in an automated plant, etc. Furthermore, the user equipment may be a radio communication module (such as an integrated circuit module including a single chip) mounted on each of the above terminals.

Examples of the base station and user equipment to which the technique of this disclosure can be applied are briefly described below.

It should be understood that the term “base station” used in this disclosure has a full breadth of its ordinary meaning and includes at least a radio communication station used as a part of a wireless communication system or radio system to facilitate communication. In D2D, M2M, and V2V communication scenarios, a logical entity having a control function for communication may also be referred to as the base station. In a cognitive radio communication scenario, a logical entity functioning as spectrum coordination may also be referred to as the base station. In an automated plant, a logical entity providing a network control function may be referred to as the base station.

### First Application Example of Base Station

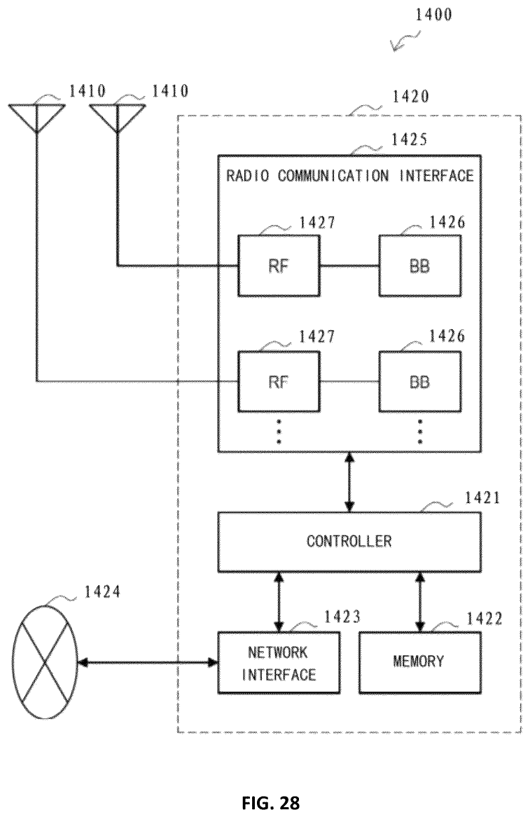

FIG. 28 is a block diagram illustrating a first example of a schematic configuration of a base station to which the technique of the present disclosure can be applied. In FIG. 28, the base station may be implemented as a gNB 1400. The gNB 1400 includes a plurality of antennas 1410 and a base station device 1420. The base station device 1420 and each antenna 1410 may be connected to each other via an RF cable.

The antenna 1410 includes a plurality of antenna elements, such as a plurality of antenna arrays for massive MIMO. The antenna 1410 may be arranged as, for example, an antenna array matrix, and used for transmitting and receiving radio signals by the base station device 1420. For example, the plurality of antennas 1410 may be compatible with a plurality of frequency bands used by the gNB 1400.

The base station device 1420 includes a controller 1421, a memory 1422, a network interface 1423, and a radio communication interface 1425.

The controller 1421 may be, for example, a CPU or DSP, and operates various functions of higher layers of the base station device 1420. For example, the controller 1421 generates a data packet according to data in a signal processed by the radio communication interface 1425, and transmits the generated packet via the network interface 1423. The controller 1421 may bundle data from a plurality of baseband processors to generate a bundle packet, and transmit the generated bundle packet. The controller 1421 may have a logic function of performing the following control: such as radio resource control, radio bearer control, mobile management, admission control and scheduling. This control may be performed in conjunction with a nearby gNB or core network node. The memory 1422 includes a RAM and a ROM, and stores a program executed by the controller 1421 and various types of control data (such as a terminal list, transmission power data, and scheduling data).

The network interface 1423 is a communication interface for connecting the base station device 1420 to a core network 1424 (e.g., a 5G core network). The controller 1421 may communicate with a core network node or another gNB via the network interface 1423. In this case, the gNB 1400 and the core network node or other gNB may be connected to each other through a logical interface (such as an NG interface and an Xn interface). The network interface 1423 may also be a wired communication interface, or a radio communication interface for a radio backhaul. If the network interface 1423 is a radio communication interface, the network interface 1423 may use a higher frequency band for radio communication, compared to a frequency band used by the radio communication interface 1425.

The radio communication interface 1425 supports any cellular communication solution (such as 5G NR), and provides a radio connection to a terminal located in a cell of the gNB 1400 via the antenna 1410. The radio communication interface 1425 may generally include, for example, a baseband (BB) processor 1426 and an RF circuit 1427. The BB processor 1426 may perform, for example, encoding/decoding, modulation/demodulation, and multiplexing/demultiplexing, and perform various types of signal processing for various layers (e.g., a physical layer, MAC layer, RLC layer, PDCP layer, SDAP layer). Instead of the controller 1421, the BB processor 1426 may have some or all of the above logic functions. The BB processor 1426 may be a memory for storing a communication control program, or a module including a processor configured to execute a program and related circuits. Updating the program may make the function of the BB processor 1426 change. The module may be a card or blade inserted into a slot of the base station device 1420. Alternatively, the module may be a chip mounted on a card or blade. Meanwhile, the RF circuit 1427 may include, for example, a mixer, a filter, and an amplifier, and transmit and receive a radio signal via the antenna 1410. Although FIG. 28 shows the example that one RF circuit 1427 is connected with one antenna 1410, the present disclosure is not limited to this illustration, and instead one RF circuit 1427 may be connected with a plurality of antennas 1410 at the same time.

As shown in FIG. 28, the radio communication interface 1425 may include a plurality of BB processors 1426. For example, the plurality of BB processors 1426 may be compatible with the plurality of frequency bands used by the gNB 1400. As shown in FIG. 28, the radio communication interface 1425 may include a plurality of RF circuits 1427. For example, the plurality of RF circuits 1427 may be compatible with the plurality of antenna elements. Although FIG. 28 shows the example where the radio communication interface 1425 includes the plurality of BB processors 1426 and the plurality of RF circuits 1427, the radio communication interface 1425 may further include a single BB processor 1426 or a single RF circuit 1427.

At least a portion of one or more units (e.g., the predetermination unit 2611, prediction unit 2612, first unit 2621, second unit 2622, third unit 2623, first unit 2631, second unit 2632, third unit 2633, fourth unit 2634, etc.) included in the processing circuits 2613, 2624, or 2635 described in conjunction with FIGS. 26A-26C can be implemented in the controller 1421 of the gNB 1400 shown in FIG. 28. At least a portion of the operation 3101 in FIG. 3A, the operation 3201 in FIG. 3B, the operation 3301 in FIG. 3C, the operations 3401 and 3402 in FIG. 3D, the operations 601-603 in FIG. 6, the operations 801-804 in FIG. 8, and the operations in FIGS. 11-13, 16-18, and 20-21 that are performed by the BS, may be implemented by the controller 1421 and/or BB processor 1426 of the gNB 1400 shown in FIG. 28.

For example, the gNB 1400 includes a portion (e.g., the BB processor 1426) or the entirety of the radio communication interface 1425 and/or a module including the controller 1421, and one or more components can be implemented in the module. In this case, the module may store a program for allowing the processor to function as one or more components (in other words, a program for allowing the processor to perform operations of one or more components), and may execute the program. As another example, a program for allowing the processor to function as one or more components can be installed in the gNB 1400, and the radio communication interface 1425 (e.g., the BB processor 1426) and/or controller 1421 can execute the program. As described above, as a device including one or more components, the gNB 1400, the base station device 1420, or the module may be provided, and the program for allowing the processor to function as one or more components may be provided. In addition, a readable medium in which the program is recorded may be provided.

### Second Application Example of Base Station

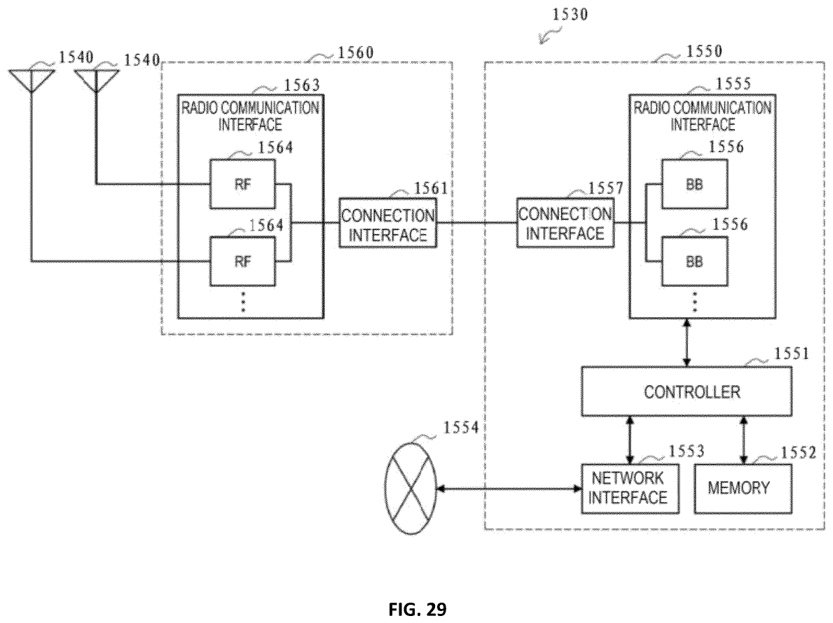

FIG. 29 is a block diagram illustrating a second example of a schematic configuration of a base station to which the technique of the present disclosure can be applied. In FIG. 29, the base station is shown as a gNB 1530. The gNB 1530 includes a plurality of antennas 1540, a base station device 1550, and an RRH 1560. The RRH 1560 and each antenna 1540 may be connected to each other via an RF cable. The base station device 1550 and the RRH 1560 may be connected to each other via a high-speed line such as an optical fiber cable.

The antenna 1540 includes a plurality of antenna elements, such as a plurality of antenna arrays for massive MIMO. The antenna 1540 may be arranged as, for example, an antenna array matrix, and used for transmitting and receiving radio signals by the base station device 1550. For example, the plurality of antennas 1540 may be compatible with a plurality of frequency bands used by the gNB 1530.

The base station device 1550 includes a controller 1551, a memory 1552, a network interface 1553, a radio communication interface 1555, and a connection interface 1557. The controller 1551, memory 1552, and network interface 1553 are the same as the controller 1421, memory 1422 and network interface 1423 described with reference to FIG. 28.

The radio communication interface 1555 supports any cellular communication solution (such as 5G NR), and provides radio communication to a terminal located in a sector corresponding to the RRH 1560 via the RRH 1560 and the antenna 1540. The radio communication interface 1555 may generally include, for example, a BB processor 1556. The BB processor 1556 is the same as the BB processor 1426 described with reference to FIG. 28, other than the BB processor 1556 being connected to an RF circuit 1564 of the RRH 1560 via the connection interface 1557. As shown in FIG. 29, the radio communication interface 1555 may include a plurality of BB processors 1556. For example, the plurality of BB processors 1556 may be compatible with the plurality of frequency bands used by the gNB 1530. Although FIG. 29 shows the example where the radio communication interface 1555 includes the plurality of BB processors 1556, the radio communication interface 1555 can also include a single BB processor 1556.

The connection interface 1557 is an interface for connecting the base station device 1550 (radio communication interface 1555) to the RRH 1560. The connection interface 1557 may also be a communication module for communication in the above high-speed line connecting the base station device 1550 (radio communication interface 1555) to the RRH 1560.

The RRH 1560 includes a connection interface 1561 and a radio communication interface 1563.

The connection interface 1561 is an interface for connecting the RRH 1560 (radio communication interface 1563) to the base station device 1550. The connection interface 1561 may also be a communication module for communication in the above high-speed line.

The radio communication interface 1563 transmits and receives radio signals via the antenna 1540. The radio communication interface 1563 may generally include, for example, the RF circuit 1564. The RF circuit 1564 may include, for example, a mixer, a filter, and an amplifier, and transmits and receives radio signals via the antenna 1540. Although FIG. 29 shows the example that one RF circuit 1564 is connected with one antenna 1540, the present disclosure is not limited to this illustration, and instead one RF circuit 1564 may be connected with a plurality of antennas 1540 at the same time.

As shown in FIG. 29, the radio communication interface 1563 may include a plurality of RF circuits 1564. For example, the plurality of RF circuits 1564 may support the plurality of antenna elements. Although FIG. 29 shows the example where the radio communication interface 1563 includes the plurality of RF circuits 1564, the radio communication interface 1563 may also include a single RF circuit 1564.

At least a portion of one or more components (e.g., the predetermination unit 2611, prediction unit 2612, first unit 2621, second unit 2622, third unit 2623, first unit 2631, second unit 2632, third unit 2633, fourth unit 2634, etc.) included in the processing circuits 2613, 2624, or 2635 described in conjunction with FIGS. 26A-26C can be implemented in the controller 1551 in the gNB 1530 shown in FIG. 29. At least a portion of the operation 3101 in FIG. 3A, the operation 3201 in FIG. 3B, the operation 3301 in FIG. 3C, the operations 3401 and 3402 in FIG. 3D, the operations 601-603 in FIG. 6, the operations 801-804 in FIG. 8, and the operations in FIGS. 11-13, 16-18, and 20-21 that are performed by the BS, may be implemented by the controller 1551 and/or BB processor 1556 of the gNB 1530 shown in FIG. 29.

For example, the gNB 1530 includes a portion (e.g., the BB processor 1556) or the entirety of the radio communication interface 1525 and/or a module including the controller 1551, and one or more components can be implemented in the module. In this case, the module may store a program for allowing the processor to function as one or more components (in other words, a program for allowing the processor to perform operations of one or more components), and may execute the program. As another example, a program for allowing the processor to function as one or more components can be installed in the gNB 1530, and the radio communication interface 1555 (e.g., the BB processor 1556) and/or the controller 1551 can perform the program. As described above, as a device including one or more components, the gNB 1530, the base station device 1550, or the module may be provided, and the program for allowing the processor to function as one or more components may be provided. In addition, a readable medium in which the program is recorded may be provided.

### First Application Example of User Equipment

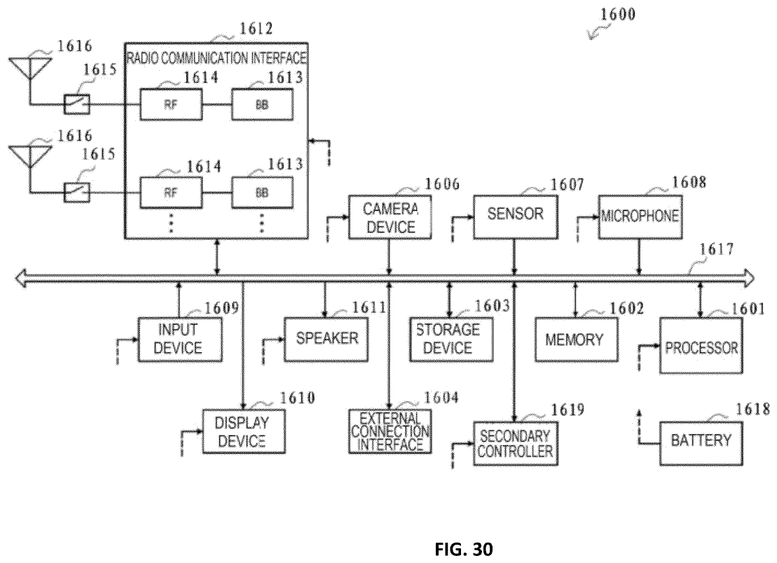

FIG. 30 is a block diagram illustrating an example of a schematic configuration of a smartphone 1600 to which the technique of the present disclosure can be applied.

The smartphone 1600 includes a processor 1601, a memory 1602, a storage device 1603, an external connection interface 1604, a camera device 1606, a sensor 1607, a microphone 1608, an input device 1609, a display device 1610, a speaker 1611, a radio communication interface 1612, one or more antenna switches 1615, one or more antennas 1616, a bus 1617, a battery 1618, and a secondary controller 1619.

The processor 1601 may be, for example, a CPU or a system on a chip (SoC), and controls functions of an application layer and other layers of the smartphone 1600. The processor 1601 may include or serve as any of the processing circuit 1001, 2001, 3001, 4001 described with reference to the accompanying drawings. The memory 1602 includes a RAM and a ROM, and stores data and a program executed by the processor 1601. The storage device 1603 may include a storage medium such as a semiconductor memory and a hard disk. The external connection interface 1604 is an interface for connecting an external device (such as a memory card and a universal serial bus (USB) device) to the smartphone 1600.

The camera device 1606 includes an image sensor (such as a charge coupled device (CCD) and a complementary metal oxide semiconductor (CMOS)), and generates a capture image. The sensor 1607 may include a set of sensors such as measurement sensors, gyro sensors, geomagnetic sensors, and acceleration sensors. The microphone 1608 converts sound input to the smartphone 1600 into an audio signal. The input device 1609 includes, for example, a touch sensor configured to detect a touch on a screen of the display device 1610, a keypad, a keyboard, a button, or a switch, and receives an operation or information input from a user. The display device 1610 includes a screen (such as a liquid crystal display (LCD) and an organic light emitting diode (OLED) display), and displays an output image of the smartphone 1600. The speaker 1611 converts an audio signal output from the smartphone 1600 into sound.

The radio communication interface 1612 supports any cellular communication solution (such as 4G LTE or 5G NR) and performs radio communication. The radio communication interface 1612 may generally include, for example, a BB processor 1613 and an RF circuit 1614. The BB processor 1613 may perform, for example, encoding/decoding, modulation/demodulation, and multiplexing/demultiplexing, and perform various types of signal processing for radio communication. Meanwhile, the RF circuit 1614 may include, for example, a mixer, a filter, and an amplifier, and transmit and receive radio signals via the antenna 1616. The radio communication interface 1612 may be one chip module having the BB processor 1613 and the RF circuit 1614 integrated thereon. As shown in FIG. 30, the radio communication interface 1612 may include a plurality of BB processors 1613 and a plurality of RF circuits 1614. Although FIG. 30 shows the example where the radio communication interface 1612 includes the plurality of BB processors 1613 and the plurality of RF circuits 1614, the radio communication interface 1612 may also include a single BB processor 1613 or a single RF circuit 1614.

Furthermore, the radio communication interface 1612 may support another type of radio communication solution, such as a short-range radio communication solution, a near field communication solution, and a wireless local area network (LAN) solution, in addition to the cellular communication solution. In this case, the radio communication interface 1612 may include the BB processor 1613 and the RF circuit 1614 for each radio communication solution.

Each of the antenna switches 1615 switches a connection destination of the antenna 1616 between a plurality of circuits (for example, circuits for different radio communication solutions) included in the radio communication interface 1612.

The antenna 1616 includes a plurality of antenna elements, such as a plurality of antenna arrays for massive MIMO. The antenna 1616 may be arranged as, for example, an antenna array matrix, and used for transmitting and receiving radio signals by the radio communication interface 1612. The smartphone 1600 may include one or more antenna panels (not shown).

Furthermore, the smartphone 1600 may include the antenna 1616 for each radio communication solution. In this case, the antenna switch 1615 may be omitted from the configuration of the smartphone 1600.

The bus 1617 connects the processor 1601, the memory 1602, the storage device 1603, the external connection interface 1604, the camera device 1606, the sensor 1607, the microphone 1608, the input device 1609, the display device 1610, the speaker 1611, the radio communication interface 1612, and the secondary controller 1619 to each other. The battery 1618 provides power to the various blocks of the smartphone 1600 shown in FIG. 30 via a feeder, which is partially shown as a dashed line in the figure. The secondary controller 1619 operates minimum necessary functions of the smartphone 1600, for example, in a sleep mode.

At least a portion of one or more units included in the processing circuits 2734 and 2744 described in conjunction with FIGS. 27C-27D (e.g., the predetermination unit 2731, sending unit 2732, receiving unit 2733, first unit 2741, second unit 2742, third unit 2743, etc.) may be implemented in the BB processor in the radio communication interface 1612 in the smartphone 1600 shown in FIG. 30. Alternatively, one or more units (e.g., the predetermination unit 2731, the sending unit 2732, the receiving unit 2733, the first unit 2741, the second unit 2742, the third unit 2743, etc.) included in the processing circuits 2734 and 2744 described in conjunction with FIGS. 27C-27D may be implemented in the processor 1601 or the secondary controller 1619 in the smart phone 1600 shown in FIG. 30. At least a portion of the operation 3101 in FIG. 3A, the operation 3201 in FIG. 3B, the operation 3301 in FIG. 3C, the operation 3401 in FIG. 3D, the operations in FIGS. 11-13, 16-18, 20-21, and 27A-27B that are performed by the UE, may be implemented by the processor 1601 and/or secondary controller 1619 and/or BB processor 1613 in the smartphone 1600 shown in FIG. 30.

As one example, the smartphone 1600 includes a portion (e.g., the BB processor 1613) or the entirety of the radio communication interface 1612, and/or a module including the processor 1601 and/or the secondary controller 1619, and one or more components may be implemented in the module. In this case, the module may store a program allowing the processer to function as one or more components (in other words, a program for allowing the processor to perform operations of one or more components), and may perform the program. As another example, a program for allowing the processor to function as one or more components may be installed in the smartphone 1600 and the radio communication interface 1612 (e.g., the BB processor 1613), the processor 1601, and/or the secondary controller 1619 may perform the program. As described above, as a device including one or more components, the smartphone 1600 or the module may be provided, and the program for allowing the processor to function as one or more components may be provided. In addition, a readable medium in which the program is recorded may be provided.

### Second Application Example of User Equipment

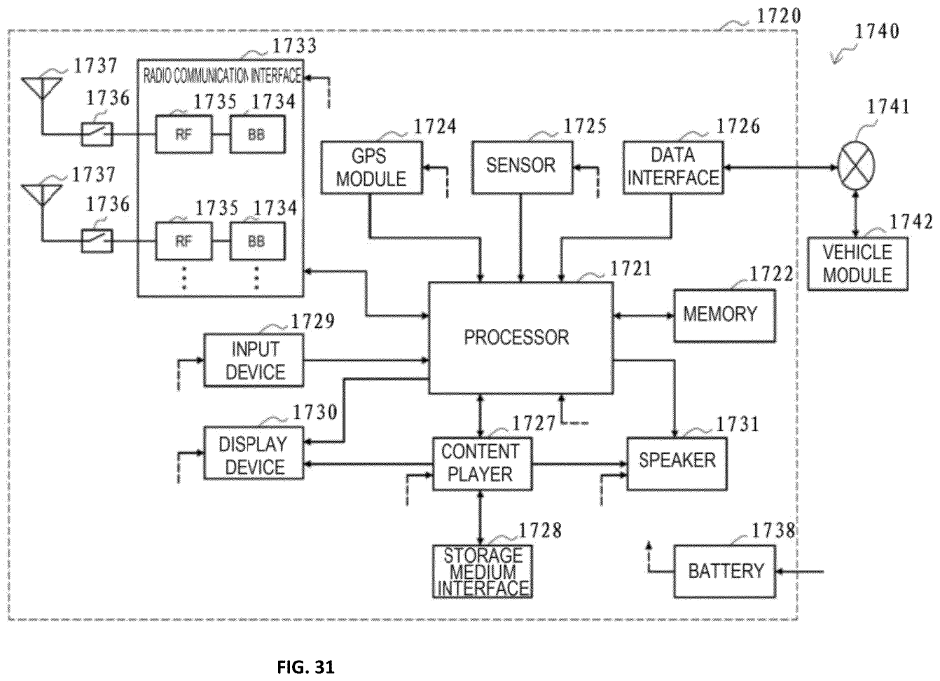

FIG. 31 is a block diagram illustrating an example of a schematic configuration of a car navigation device 1720 to which the technique of the present disclosure can be applied. The car navigation device 1720 includes a processor 1721, a memory 1722, a global positioning system (GPS) module 1724, a sensor 1725, a data interface 1726, a content player 1727, a storage medium interface 1728, an input device 1729, a display device 1730, a speaker 1731, a radio communication interface 1733, one or more antenna switches 1736, one or more antennas 1737, and a battery 1738.

The processor 1721 may be, for example, a CPU or SoC, and control a navigation function and other functions of the car navigation device 1720. The memory 1722 includes a RAM and a ROM, and stores data and a program executed by the processor 1721.

The GPS module 1724 measures a location (such as latitude, longitude, and altitude) of the car navigation device 1720 using a GPS signal received from a GPS satellite. The sensor 1725 may include a set of sensors such as gyroscope sensors, geomagnetic sensors, and air pressure sensors. The data interface 1726 is, via a terminal not shown, connected to, for example, a car-mounted network 1741, and acquires data (such as vehicle velocity data) generated by a vehicle.

The content player 1727 reproduces content stored in a storage medium (such as a CD and a DVD), which is inserted into the storage medium interface 1728. The input device 1729 includes, for example, a touch sensor configured to detect a touch on a screen of the display device 1730, a button, or a switch, and receives an operation or information input from a user. The display device 1730 includes a screen such as an LCD or OLED display, and displays an image of a navigation function or reproduced content. The speaker 1731 outputs sound of the navigation function or reproduced content.

The radio communication interface 1733 supports any cellular communication solution (such as 4G LTE or 5G NR) and performs radio communication. The radio communication interface 1733 may generally include, for example, a BB processor 1734 and an RF circuit 1735. The BB processor 1734 may perform, for example, encoding/decoding, modulation/demodulation, and multiplexing/demultiplexing, and perform various types of signal processing for radio communication. Meanwhile, the RF circuit 1735 may include, for example, a mixer, a filter, and an amplifier, and transmit and receive radio signals via the antenna 1737. The radio communication interface 1733 may also be a chip module having the BB processor 1734 and the RF circuit 1735 integrated thereon. As shown in FIG. 31, the radio communication interface 1733 may include a plurality of BB processors 1734 and a plurality of RF circuits 1735. Although FIG. 31 shows the example where the radio communication interface 1733 includes the plurality of BB processors 1734 and the plurality of RF circuits 1735, the radio communication interface 1733 may also include a single BB processor 1734 or a single RF circuit 1735.

Furthermore, the radio communication interface 1733 may support another type of radio communication solution, such as a short-range radio communication solution, a near field communication solution, and a wireless LAN solution, in addition to the cellular communication solution. In this case, for each radio communication solution, the radio communication interface 1733 may include the BB processor 1734 and the RF circuit 1735.

Each of the antenna switches 1736 switches a connection destination of the antenna 1737 between a plurality of circuits (such as circuits for different radio communication solutions) included in the radio communication interface 1733.

The antenna 1737 includes a plurality of antenna elements, such as a plurality of antenna arrays for massive MIMO. The antenna 1737 may be arranged as, for example, an antenna array matrix, and used for transmitting and receiving radio signals by the radio communication interface 1733.

Furthermore, the car navigation device 1720 may include an antenna 1737 for each radio communication solution. In this case, the antenna switch 1736 may be omitted from the configuration of the car navigation device 1720.

The battery 1738 provides power to the various blocks of the car navigation device 1720 shown in FIG. 31 via a feeder, which is partially shown as a dashed line in the figure. The battery 1738 accumulates power supplied from the vehicle.

At least a portion of one or more units (e.g., the predetermination unit 2731, the sending unit 2732, the receiving unit 2733, the first unit 2741, the second unit 2742, the third unit 2743, etc.) included in the processing circuits 2734 and 2744 described in conjunction with FIGS. 27C-27D can be implemented in the BB processor 1734 in the radio communication interface 1733 in the car navigation device 1720 shown in FIG. 31. Alternatively, one or more units (e.g., the predetermination unit 2731, the sending unit 2732, the receiving unit 2733, the first unit 2741, the second unit 2742, the third unit 2743, etc.) included in the processing circuits 2734 and 2744 described in conjunction with FIGS. 27C-27D may be implemented in the processor 1721 in the car navigation device 1720 illustrated in FIG. 31. At least a portion of the operation 3101 in FIG. 3A, the operation 3201 in FIG. 3B, the operation 3301 in FIG. 3C, the operation 3401 in FIG. 3D, and the operations in FIGS. 11-13, 16-18, 20-21, and 27A-27B that are performed by the UE, may be implemented by the BB processor 1734 and/or processor 1721 in the car navigation device 1720 shown in FIG. 31.

As one example, the car navigation device 1720 includes a portion (e.g., the BB processor 1734) or the entirety of the radio communication interface 1733 and/or a module including the processor 1721, and one or more components may be implemented in the module. In this case, the module may store a program allowing the processor to function as one or more components (in other words, a program for allowing the processor to perform operations of one or more components), and may execute the program. As another example, a program for allowing the processor to function as one or more components may be installed in the car navigation device 1720, and the radio communication interface 1733 (e.g., the BB processor 1734) and/or the processor 1721 may execute the program. As described above, as a device including one or more components, the car navigation device 1720 or the module may be provided, and the program for allowing the processor to function as one or more components may be provided. In addition, a readable medium in which the program is recorded may be provided.

The technique of this disclosure may also be implemented as a car-mounted system (or vehicle) 1740 including the car navigation device 1720, a car-mounted network 1741, and one or more blocks in a vehicle module 1742. The vehicle module 1742 generates vehicle data (such as vehicle velocity, engine velocity, and fault information) and outputs the generated data to the car-mounted network 1741.

The exemplary embodiments of the present disclosure have been described above with reference to the drawings, but the present disclosure is of course not limited to the above examples. Those skilled in the art may obtain various changes and modifications within the scope of the attached claims, and should understand that these changes and modifications will naturally fall within the technical scope of the present disclosure.

For example, a plurality of functions included in one unit in the above embodiments may be implemented by separate devices. Alternatively, a plurality of functions implemented by a plurality of units in the above embodiments may be implemented by separate devices, respectively. In addition, one of the above functions may be implemented by a plurality of units. Needless to say, such a configuration is included within the technical scope of the present disclosure.

In this description, the steps described in the flow diagrams include not only the processing performed in the temporal sequence in the described order but also the processing performed in parallel or individually rather than necessarily in the temporal sequence. Furthermore, even in the steps of the processing in the temporal sequence, needless to say, the order can be appropriately changed.

Although the present disclosure and its advantages have been described in detail, it should be understood that various changes, substitutions and alterations can be made without departing from the spirit and scope of the present disclosure that are defined by the attached claims. Moreover, the terms “comprise”, “include”, or any other variation thereof in the embodiments of the present disclosure are intended to cover a non-exclusive inclusion, such that a process, method, article, or device that comprises a list of elements not only includes those elements, but also includes other elements not expressly listed, or elements inherent to such a process, method, article, or device. Without more limitations, an element defined by a statement “comprising one . . . ” does not exclude the presence of another identical element in a process, method, article, or device that includes the element.

What is claimed is:

1. A method for radio communication, comprising:
predetermining that a radio link failure (RLF) or handover will occur by using an artificial intelligence (AI) model, wherein, the predetermination is based at least on radio link condition information related to a user equipment (UE), and the radio link condition information comprises at least information reflecting condition of a radio link between the UE and a serving base station (SBS).

2. The method according to claim 1, further comprising:
in response to the predetermination, predicting a target base station and a beam used by the target base station to serve the user equipment for configuring a conditional handover, by using the AI model, wherein, the prediction is based at least on the radio link condition information related to the UE.

3. The method according to claim 2, wherein an output of the AI model comprises a target base station-beam set, the target base station-beam set comprising one or more target base station-beam pairings, each pairing indicating one target base station and one beam used by the target base station to serve the user equipment that are predicted.

4. The method according to claim 1, wherein the radio link condition information further comprises information reflecting condition of a radio link between the UE and one or more neighboring base stations.

5. The method according to claim 3, wherein the radio link condition information comprises at least one of:
a beam measurement result;
a channel state information (CSI) measurement result;
a mobility measurement result;
real-time geographic environment and radio environment information comprising at least one of a high-precision map or an electromagnetic map;
a location and motion feature of the UE; or
data of sensors comprising at least one of an accelerometer or barometer of the UE.

6. The method according to claim 5, wherein the AI model comprises one or more AI sub-models, an input of each AI sub-model in the AI model comprising at least the radio link condition information related to the UE.

7. The method according to claim 6, wherein the AI model comprises a first AI sub-model deployed at the serving base station, the method further comprising:
predicting, by the serving base station, an occurrence probability of the RLF or handover and a target base station-beam set by using the first AI sub-model, based at least on the radio link condition information related to the UE;
predetermining, by the serving base station, that the RLF or handover will occur based on a comparison of the occurrence probability of the RLF or handover with a preset threshold; and
in response to the predetermination, using, by the serving base station, the target base station-beam set for configuring the conditional handover.

8. The method according to claim 6, wherein the AI model comprises a second AI sub-model and a third AI sub-model deployed at the serving base station, the method further comprising:
predicting, by the serving base station, an occurrence probability of the RLF or handover by using the second AI sub-model, based on the radio link condition information related to the UE;
predetermining, by the serving base station, that the RLF or handover will occur based on a comparison of the occurrence probability of the RLF or handover with a preset threshold; and
in response to the predetermination, predicting, by the serving base station, a target base station-beam set for configuring the conditional handover by using the third AI sub-model, based on the radio link condition information related to the UE and supplementary radio link condition information related to the UE.

9. The method according to claim 7, wherein the AI model further comprises a fourth AI sub-model deployed at the UE, the method further comprising:
predicting, by the UE, the occurrence probability of the RLF or handover by using the fourth AI sub-model, based at least on the radio link condition information related to the UE; and
sending, by the UE, the predicted occurrence probability of the RLF or handover to the serving base station,
the occurrence probability of the RLF or handover of the UE being comprised in the radio link condition information related to the UE.

10. The method according to claim 6, wherein the AI model comprises a fifth AI sub-model deployed at the UE and a sixth AI sub-model deployed at the serving base station, the method further comprising:
predicting, by the UE, an occurrence probability of the RLF or handover by using the fifth AI sub-model, based at least on the radio link condition information related to the UE;
sending, by the UE, the predicted occurrence probability of the RLF or handover to the serving base station;
predetermining, by the serving base station, that the RLF or handover will occur based on a comparison of the predicted occurrence probability of the RLF or handover that is received from the UE with a preset threshold; and
in response to the predetermination, predicting, by the serving base station, a target base station-beam set for configuring the conditional handover by using the sixth AI sub-model, based at least on the radio link condition information related to the UE.

11. The method according to claim 5, wherein beam measurement is triggered based on at least one of being below a preset communication quality threshold or response to the predetermination that the RLF or handover will occur,
wherein, the beam measurement is based on at least one of:
(1) adjacent beam measurement, in which a beam adjacent to a current serving beam in angle is measured; or
(2) beam measurement based on probability priorities, in which a number of beams with each beam being selected based on a predicted probability that the beam becomes an optimal beam are measured.

12. The method according to claim 5, further comprising:
configuring, by the serving base station, channel state information reference signal (CSI-RS) resources for downlink beam failure recovery (BFR) measurement;
sending, by the serving base station, a CSI-RS for performing the downlink BFR measurement by the UE;
sending, by the UE, a downlink BFR measurement result to the service base station; and
sending, by the UE, a UE receiving beam pattern to the serving base station,
wherein, the beam measurement result comprises the downlink BFR measurement result and the UE receiving beam pattern.

13. The method according to claim 5, further comprising:
configuring, by the serving base station, sounding reference signal (SRS) resources for uplink BFR measurement;
notifying, by the serving base station, the configured SRS resources to the UE;
sending, by the UE, an SRS;
performing, by the serving base station, the uplink BFR measurement to obtain a uplink BFR measurement result; and
feeding back, by the UE, a UE transmitting beam pattern to the serving base station,
wherein, the beam measurement result comprises the uplink BFR measurement result and the UE transmitting beam pattern.

14. A system for radio communication, comprising:
one or more processors,
a memory storing computer-readable program instructions which, when executed by the one or more processors, cause the method according to claim 1 to be performed.

15. A non-transitory computer-readable storage medium storing computer-readable program instructions which, when executed by one or more processors, cause the method for radio communication according to claim 1 to be performed.

16. A method performed by a user equipment (UE), comprising:
predicting an occurrence probability of a radio link failure (RLF) or handover by using a first artificial intelligence (AI) model, the prediction being based at least on radio link condition information related to a user equipment (UE), the radio link condition information comprising at least information reflecting condition of a radio link between the UE and a serving base station.

17. The method according to claim 16, further comprising:
sending the predicted occurrence probability of the RLF or handover to the serving base station.

18. The method according to claim 17, further comprising:
predetermining that the RLF or handover will occur based on a comparison of the occurrence probability of the RLF or handover with a preset threshold; and
in response to the predetermination, notifying the serving base station of predicting that the RLF or handover will occur.

19. A user equipment (UE), comprising
one or more of processors,
a memory storing computer-readable program instructions which, when executed by the one or more processors, cause the method according to claim 16 to be performed.

20. A non-transitory computer-readable storage medium storing computer-readable program instructions which, when executed by one or more processors, cause the method performed by a user equipment (UE) according to claim 16 to be performed.
